(19) United States
(12) Patent Application Publication
(10) Pub. No.: US 2009/0182138 A1
(43) Pub. Date: Jul. 16, 2009

(54) METHOD FOR ACYLATING CELLULOSE WITH A SPECIFIC AVERAGE DEGREE OF POLYMERIZATION

(75) Inventors: Klemens Massonne, Bad Dürkheim (DE); Veit Stegmann, Mannheim (DE); Giovanni D'Andola, Heidelberg (DE); Werner Mormann, Siegen (DE); Markus Wezstein, Kirchhundem (DE); Wei Leng, Siegen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/305,004

(22) PCT Filed: Jun. 20, 2007
(86) PCT No.: PCT/EP07/56105

§ 371 Date: Dec. 16, 2008

(30) Foreign Application Priority Data
Jun. 30, 2006 (DE) 10 2006 030 696.1
Sep. 9, 2006 (DE) 10 2006 042 892.7

(51) Int. Cl. C08B 15/00

(52) U.S. Cl. 536/124

(57) ABSTRACT

The present invention describes a process for acylating polysaccharides or oligosaccharides, which comprises dissolving a polysaccharide or oligosaccharide in at least one ionic liquid and,
in step A) treating the solution with at least one acid, if appropriate with addition of water, (step A1) or,
   if appropriate with addition of water, at elevated temperature (step A2) and,
in step B) reacting the polysaccharide or oligosaccharide obtained in this way, whose DP is lower than that of the polysaccharide or oligosaccharide used, with an acylating agent.

The present invention describes a process for acylating cellulose with a targeted average degree of polymerization (DP), in which cellulose is subjected, in an ionic liquid, to a targeted degradation in a first step and an acylation in a second step.

Cellulose is the most important renewable raw material and represents an important starting material for, for example, the textile, paper and nonwovens industries. It also serves as raw material for derivatives and modifications of cellulose, including cellulose ethers such as methylcellulose and carboxymethylcellulose, cellulose esters based on organic acids, e.g. cellulose acetate, cellulose butyrate, and cellulose esters based on inorganic acids, e.g. cellulose nitrate, and others. These derivatives and modifications have many uses, for example in the textile, food, building and surface coating industries. There is particular interest here in cellulose acetate.

In the industrial preparation of cellulose acetate, cotton linters or processed wood pulp is reacted with acetic anhydride in the presence of sulfuric acid or perchloric acid as catalyst. In this procedure, both a decrease in the DP and acylation of the hydroxy functions of the anhydroglucose units of the cellulose occur. The decrease in the chain length of the cellulose molecule is attributed to hydrolytic cleavage of the glycosidic bonds as a consequence of the strongly acidic reaction conditions. Furthermore, the cellulose acetate obtained in this way has a degree of substitution (DS) of 3 (=cellulose triacetate). However, a DS of about 2.5 is necessary for spinning. Cellulose triacetate is therefore subjected to a partial deacylation. A disadvantage here is that a heterogeneous mixture is initially present in this process and this goes over into a more or less homogeneous mixture during the course of the reaction. The handling of such mixtures is very demanding in engineering terms. Another disadvantage is that a cellulose acetate having a DS of 3 is primarily obtained. Furthermore, the DP of the cellulose acetate obtained depends greatly on the quality of the cellulose used and on the reaction conditions.

There is therefore a need to provide a simple process for the targeted preparation of acylated celluloses having a targeted DP and a defined DS.

We have now found a process for preparing acylated celluloses having a targeted DP and a defined DS, in which cellulose is dissolved in an ionic liquid and the solution obtained in this way is, in a first step (step A), treated with an acid (if appropriate with addition of water) or at elevated temperature (if appropriate in the presence of water) and, in a second step (step B), the cellulose obtained in this way, whose DP is lower than that of the cellulose used in step A, is reacted with an acylating agent.

For the purposes of the present invention, ionic liquids are preferably

(A) salts of the general formula (I)

[A]ₙ⁺[Y]ⁿ⁻ (I),
where n is 1, 2, 3 or 4, [A]⁺ is a quaternary ammonium cation, an oxonium cation, a sulfonium cation or a phosphonium cation and [Y]ₙ₋ is a monovalent, divalent, trivalent or tetravalent anion;

(B) mixed salts of the general formulae (II)

[A¹]⁺[A²]⁺[Y]ₙ₋ (IIa),
where n=2;

[A¹]⁺[A²]⁺[A³]⁺[Y]ₙ₋ (IIb),
where n=3; or

[A¹]⁺[A²]⁺[A³]⁺[A⁴]⁺[Y]ₙ₋ (IIc),
where n=4,
where [A¹]⁺, [A²]⁺, [A³]⁺ and [A⁴]⁺ are selected independently from among the groups mentioned for [A]⁺ and [Y]ₙ₋ is as defined under (A).

The ionic liquids preferably have a melting point of less than 180° C. The melting point is particularly preferably in the range from −50° C. to 150° C., in particular in the range from −20° C. to 120° C. and extraordinarily preferably below 100° C.

The ionic liquids used according to the invention are organic compounds, i.e. at least one cation or anion of the ionic liquid comprises an organic radical.

Compounds suitable for the formation of the cation [A]⁺ of ionic liquids are known, for example, from DE 102 02 838 A1. Thus, such compounds can comprise oxygen, phosphorus, sulfur or in particular nitrogen atoms, for example at least one nitrogen atom, preferably from 1 to 10 nitrogen atoms, particularly preferably from 1 to 5 nitrogen atoms, very particularly preferably from 1 to 3 nitrogen atoms and in particular 1 or 2 nitrogen atoms. If appropriate, further heteroatoms such as oxygen, sulfur or phosphorus atoms can also be comprised. The nitrogen atom is a suitable carrier of the positive charge in the cation of the ionic liquid, from which a proton or an alkyl radical can then go over in equilibrium to the anion to produce an electrically neutral molecule.

If the nitrogen atom is the carrier of the positive charge in the cation of the ionic liquid, a cation can firstly be produced by quaternization of the nitrogen atom of, for instance, an amine or nitrogen heterocycle in the synthesis of the ionic liquids. Quaternization can be effected by alkylation of the nitrogen atom. Depending on the alkylation reagent used, salts having different anions are obtained. In cases in which it is not possible to form the desired anion in the quaternization itself, this can be brought about in a further step of the synthesis. Starting from, for example, an ammonium halide, the halide can be reacted with a Lewis acid, forming a complex anion from the halide and Lewis acid. As an alternative, replacement of a halide ion by the desired anion is possible. This can be achieved by addition of a metal salt with precipitation of the metal halide formed, by means of an ion exchanger or by displacement of the halide ion by a strong acid (with liberation of the hydrogen halide). Suitable methods are described, for example, in Angew. Chem. 2000, 112, pp. 3926-3945, and the references cited therein.

Suitable alkyl radicals by means of which the nitrogen atom in the amines or nitrogen heterocycles can, for example, be quaternized are C₁-C₁₈-alkyl, preferably C₁-C₁₀-alkyl, particularly preferably C₁-C₆-alkyl and very particularly preferably methyl. The alkyl group can be unsubstituted or have one or more identical or different substituents.

Preference is given to compounds which comprise at least one five- or six-membered heterocycle, in particular a five-membered heterocycle, which has at least one nitrogen atom and also, if appropriate, an oxygen or sulfur atom. Particular preference is likewise given to compounds which comprise at least one five- or six-membered heterocycle which has one, two or three nitrogen atoms and a sulfur or oxygen atom, very particularly preferably compounds having two nitrogen atoms. Further preference is given to aromatic heterocycles.

Particularly preferred compounds have a molecular weight below 1000 g/mol, very particularly preferably below 500 g/mol and in particular below 350 g/mol.

Furthermore, preference is given to cations selected from among the compounds of the formulae (IIIa) to (IIIw),

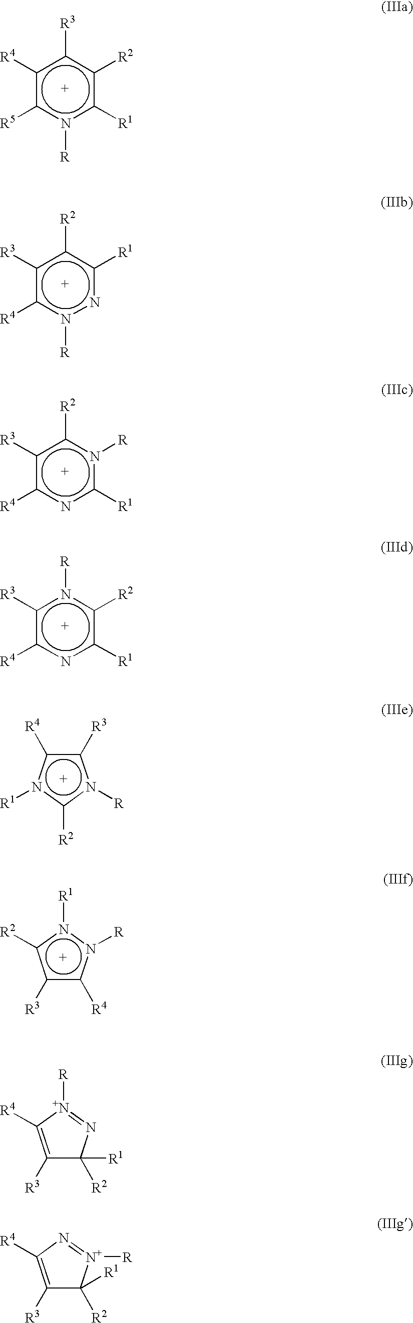

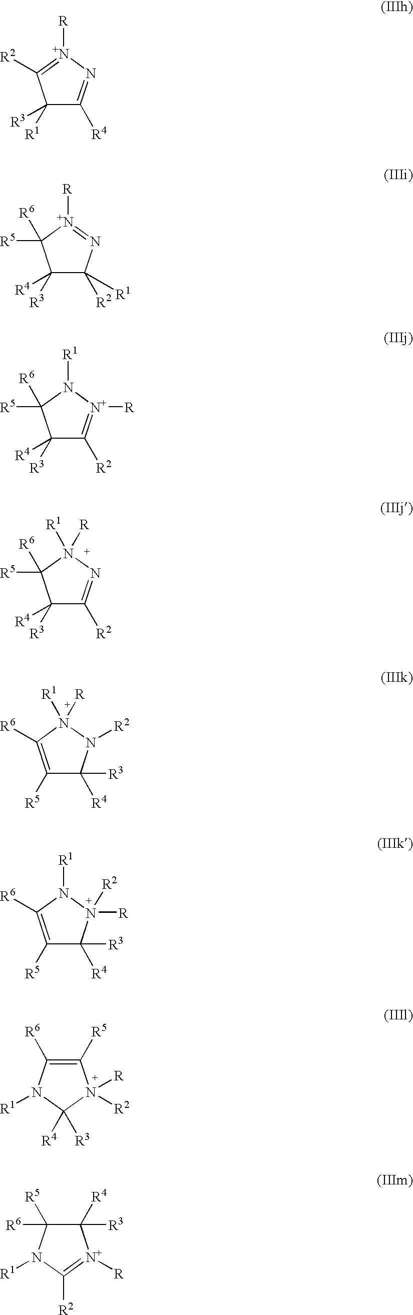

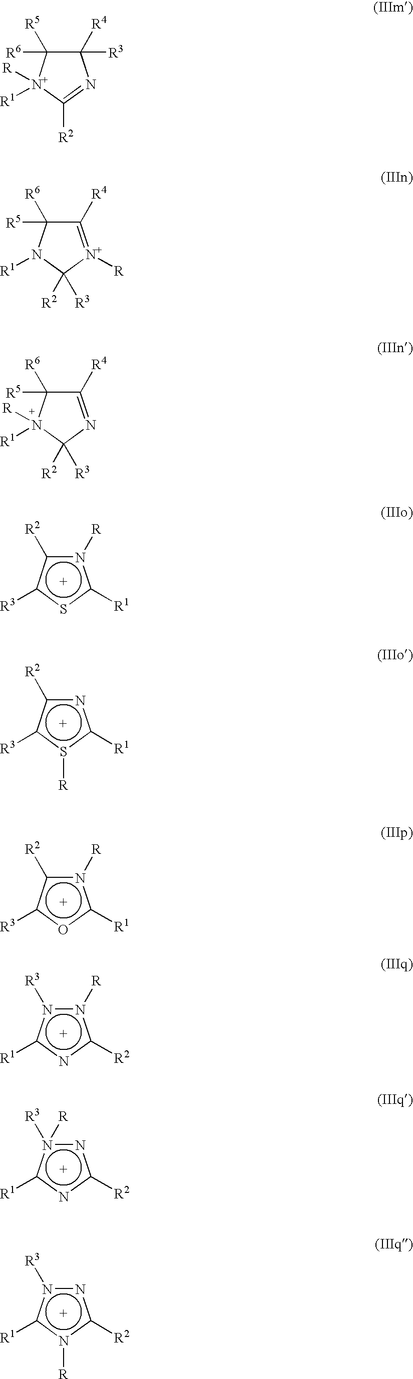

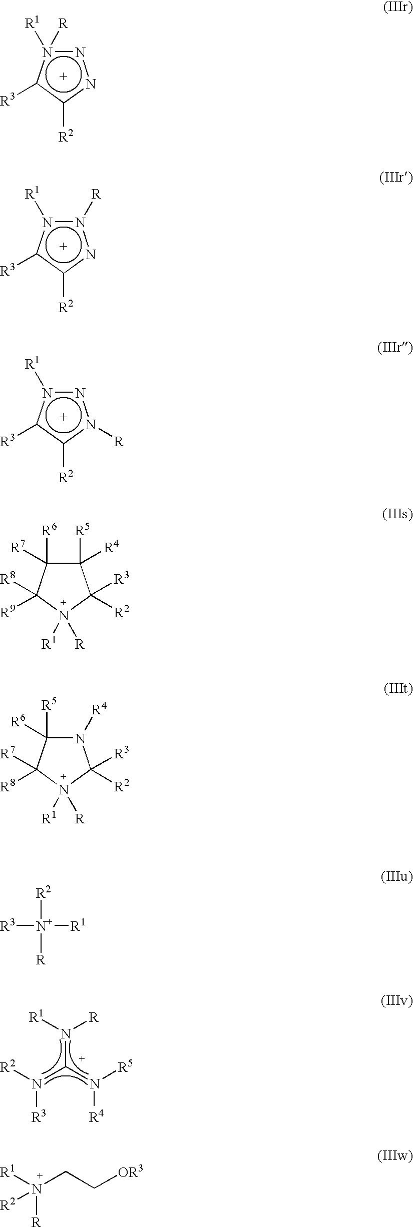

and oligomers comprising these structures.

Further suitable cations are compounds of the general formulae (IIIx) and (IIIy)

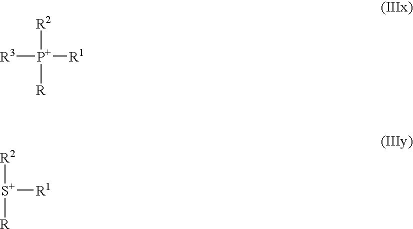

and oligomers comprising these structures.

In the abovementioned formulae (IIIa) to (IIIy),
the radical R is hydrogen or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups; and
the radicals R¹ to R⁹ are each, independently of one another, hydrogen, a sulfo group or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups, where the radicals R¹ to R⁹ which are bound to a carbon atom (and not to a heteroatom) in the formulae (II) mentioned above are additionally able to be halogen or a functional group; or
two adjacent radicals from the group consisting of R¹ to R⁹ may together also form a divalent, carbon-comprising organic, saturated or unsaturated, acyclic or cyclic, aliphatic, aromatic or araliphatic radical which has from 1 to 30 carbon atoms and may be unsubstituted or be interrupted or substituted by from 1 to 5 heteroatoms or functional groups.

In the definitions of the radicals R and R¹ to R⁹, possible heteroatoms are in principle all heteroatoms which are able to formally replace a —CH₂— group, a —CH═ group, a —C— group or a ═C═ group. If the carbon-comprising radical comprises heteroatoms, then oxygen, nitrogen, sulfur, phosphorus and silicon are preferred. Preferred groups are, in particular, —O—, —S—, —SO—, —SO₂—, —NR′—, —N═, —PR′—, —PR′₃ and —SiR′₂—, where the radicals R′ are the remaining part of the carbon-comprising radical. In the cases in which the radicals R¹ to R⁹ are bound to a carbon atom (and not a heteroatom) in the abovementioned formulae (II), they can also be bound directly via the heteroatom.

Suitable functional groups are in principle all functional groups which can be bound to a carbon atom or a heteroatom. Suitable examples are OH (hydroxy), ═O (in particular as carbonyl group), —NH₂ (amino), —NHR′, —NR₂′, ═NH (imino), ═NR′, —COOH (carboxy), CONH₂ (carboxamide), —SO₃H (sulfo) and —CN (cyano). Functional groups and heteroatoms can also be directly adjacent, so that combinations of a plurality of adjacent atoms, for instance —O— (ether), —S-(thioether), —COO— (ester), —CONH— (secondary amide) or —CONR′— (tertiary amide), are also comprised, for example di-(C₁-C₄-alkyl)amino, C₁-C₄-alkyloxycarbonyl or C₁-C₄-alkyloxy. The radicals R′ are the remaining part of the carbon-comprising radical.

As halogens, mention may be made of fluorine, chlorine, bromine and iodine.

The radical R is preferably
unbranched or branched C₁-C₁₈-alkyl which may be unsubstituted or substituted by one or more hydroxy, halogen, phenyl, cyano, C₁-C₆-alkoxycarbonyl and/or SO₃H groups and has a total of from 1 to 20 carbon atoms, for example methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, 2-hydroxyethyl, benzyl, 3-phenylpropyl, 2-cyanoethyl, 2-(methoxycarbonyl)ethyl, 2-(ethoxycarbonyl)ethyl, 2-(n-butoxycarbonyl)ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluoroisopentyl, 6-hydroxyhexyl and propylsulfonic acid;
glycols, butylene glycols and oligomers thereof having from 1 to 100 units and a hydrogen or a C₁-C₈-alkyl as end group, for example R^{A}O—(CHR^{B}—CH₂—O)ₘ—CHR^{B}—CH₂— or R^{A}O—(CH₂CH₂CH₂CH₂O)ₘ—CH₂CH₂CH₂CH₂— where R^{A} and R^{B} are each preferably hydrogen, methyl or ethyl and m is preferably 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxamidecyl and 3,6,9,12-tetraoxatetradecyl;
vinyl;
1-propen-1-yl, 1-propen-2-yl and 1-propen-3-yl; and
N,N-di-C₁-C₆-alkylamino such as N,N-dimethylamino and N,N-diethylamino.

The radical R is particularly preferably unbranched and unsubstituted C₁-C₁₈-alkyl, such as methyl, ethyl, 1-propyl, 1-butyl, 1-pentyl, 1-hexyl, 1-heptyl, 1-octyl, 1-decyl, 1-dodecyl, 1-tetradecyl, 1-hexadecyl, 1-octadecyl, 1-propen-3-yl, in particular methyl, ethyl, 1-butyl and 1-octyl, or CH₃O—(CH₂CH₂O)ₘ—CH₂CH₂— and CH₃CH₂O—(CH₂CH₂O)ₘ—CH₂CH₂— where m is 0 to 3.

Preference is given to the radicals R¹ to R⁹ each being, independently of one another,
hydrogen;
halogen;
a functional group;
C₁-C₁₈-alkyl which may optionally be substituted by functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups;
C₂-C₁₈-alkenyl which may optionally be substituted by functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups;
C₆-C₁₂-aryl which may optionally be substituted by functional groups, aryl, alkyl, aryloxy, alkyloxy, halogen, heteroatoms and/or heterocycles;
C₅-C₁₂-cycloalkyl which may optionally be substituted by functional groups, aryl, alkyl, aryloxy, alkyloxy, halogen, heteroatoms and/or heterocycles;
C₅-C₁₂-cycloalkenyl which may optionally be substituted by functional groups, aryl, alkyl, aryloxy, alkyloxy, halogen, heteroatoms and/or heterocycles; or
a five- or six-membered oxygen-, nitrogen- and/or sulfur-comprising heterocycle which may optionally be substituted by functional groups, aryl, alkyl, aryloxy, alkyloxy, halogen, heteroatoms and/or heterocycles; or
   two adjacent radicals together form
an unsaturated, saturated or aromatic ring which may optionally be substituted by functional groups, aryl, alkyl, aryloxy, alkyloxy, halogen, heteroatoms and/or heterocycles and may optionally be interrupted by one or more oxygen and/or sulfur atoms and/or one or more substituted or unsubstituted imino groups.

C₁-C₁₈-alkyl which may optionally be substituted by functional groups, aryl, alkyl, aryloxy, alkyloxy, halogen, heteroatoms and/or heterocycles is preferably methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, 2-ethylhexyl, 2,4,4-trimethylpentyl, 1,1,3,3-tetramethylbutyl, 1-nonyl, 1-decyl, 1-undecyl, 1-dodecyl, 1-tridecyl, 1-tetradecyl, 1-pentadecyl, 1-hexadecyl, 1-heptadecyl, 1-octadecyl, cyclopentylmethyl, 2-cyclopentylethyl, 3-cyclopentylpropyl, cyclohexylmethyl, 2-cyclohexylethyl, 3-cyclohexylpropyl, benzyl (phenylmethyl), diphenylmethyl (benzhydryl), triphenylmethyl, 1-phenylethyl, 2-phenylethyl, 3-phenylpropyl, α,α-dimethylbenzyl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di-(methoxycarbonyl)ethyl, methoxy, ethoxy, formyl, 1,3-dioxolan-2-yl, 1,3-dioxan-2-yl, 2-methyl-1,3-dioxolan-2-yl, 4-methyl-1,3-dioxolan-2-yl, 2-hydroxyethyl, 2-hydroxypropyl, 3-hydroxypropyl, 4-hydroxybutyl, 6-hydroxyhexyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl, 6-ethoxyhexyl, acetyl, CₘF_{2(m-a)+(1-b)}H_{2a+b} where m is from 1 to 30, 0≦a≦m and b=0 or 1 (for example CF₃, C₂F₅, CH₂CH₂—C₍ₘ₋₂₎F₂₍ₘ₋₂₎₊₁, C₆F₁₃, C₈F₁₇, C₁₀F₂₁, C₁₂F₂₅), chloromethyl, 2-chloroethyl, trichloromethyl, 1,1-dimethyl-2-chloroethyl, methoxymethyl, 2-butoxyethyl, diethoxymethyl, diethoxyethyl, 2-isopropoxyethyl, 2-butoxypropyl, 2-octyloxyethyl, 2-methoxyisopropyl, 2-(methoxycarbonyl)ethyl, 2-(ethoxycarbonyl)ethyl, 2-(n-butoxycarbonyl)ethyl, butylthiomethyl, 2-dodecylthioethyl, 2-phenylthioethyl, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8,-dioxaundecyl, 15-hydroxy-4,8,12-trioxapentadecyl, 9-hydroxy-5-oxanonyl, 14-hydroxy-5,10-dioxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-dioxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

C₂-C₁₈-alkenyl which may optionally be substituted by functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups is preferably vinyl, 2-propenyl, 3-butenyl, cis-2-butenyl, trans-2-butenyl or CₘF_{2(m-a)-(1-b)}H_{2a-b} where m≦30, 0≦a≦m and b=0 or 1.

C₆-C₁₂-aryl which may optionally be substituted by functional groups, aryl, alkyl, aryloxy, alkyloxy, halogen, heteroatoms and/or heterocycles is preferably phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2-nitrophenyl, 4-nitrophenyl, 2,4-dinitrophenyl, 2,6-dinitrophenyl, 4-dimethylaminophenyl, 4-acetylphenyl, methoxyethylphenyl, ethoxymethylphenyl, methylthiophenyl, isopropylthiophenyl or tert-butylthiophenyl or C₆F₍₅₋ₐ₎H, where 0≦a≦5.

C₅-C₁₂-cycloalkyl which may optionally be substituted by functional groups, aryl, alkyl, aryloxy, alkyloxy, halogen, heteroatoms and/or heterocycles is preferably cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl, CₘF_{2(m-a)-(1-b)}H_{2a-b} where m≦30, 0≦a≦m and b=0 or 1, or a saturated or unsaturated bicyclic system such as norbornyl or norbornenyl.

C₅-C₁₂-Cycloalkenyl which may optionally be substituted by functional groups, aryl, alkyl, aryloxy, alkyloxy, halogen, heteroatoms and/or heterocycles is preferably 3-cyclopentenyl, 2-cyclohexenyl, 3-cyclohexenyl, 2,5-cyclohexadienyl or CₙF_{2(m-a)-3(1-b)}H_{2a-3b} where m≦30, 0≦a≦m and b=0 or 1.

A five- or six-membered, oxygen-, nitrogen- and/or sulfur-comprising heterocycle which may optionally be substituted by functional groups, aryl, alkyl, aryloxy, alkyloxy, halogen, heteroatoms and/or heterocycles is preferably furyl, thiophenyl, pyrryl, pyridyl, indolyl, benzoxazolyl, dioxolyl, dioxyl, benzimidazolyl, benzthiazolyl, dimethylpyridyl, methylquinolyl, dimethylpyrryl, methoxyfuryl, dimethoxypyridyl or difluoropyridyl.

If two adjacent radicals together form an unsaturated, saturated or aromatic ring which may optionally be substituted by functional groups, aryl, alkyl, aryloxy, alkyloxy, halogen, heteroatoms and/or heterocycles and may optionally be interrupted by one or more oxygen and/or sulfur atoms and/or one or more substituted or unsubstituted imino groups, they preferably form 1,3-propylene, 1,4-butylene, 1,5-pentylene, 2-oxa-1,3-propylene, 1-oxa-1,3-propylene, 2-oxa-1,3-propylene, 1-oxa-1,3-propenylene, 3-oxa-1,5-pentylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

If the abovementioned radicals comprise oxygen and/or sulfur atoms and/or substituted or unsubstituted imino groups, the number of oxygen and/or sulfur atoms and/or imino groups is not subject to any restrictions. In general, there will be no more than 5 in the radical, preferably no more than 4 and very particularly preferably no more than 3.

If the abovementioned radicals comprise heteroatoms, there is generally at least one carbon atom, preferably at least two carbon atoms, between any two heteroatoms.

Particular preference is given to the radicals R¹ to R⁹ each being, independently of one another,
hydrogen;
unbranched or branched C₁-C₁₈-alkyl which may be unsubstituted or substituted by one or more hydroxy, halogen, phenyl, cyano, and/or C₁-C₆-alkoxycarbonyl and/or SO₃H groups and has a total of from 1 to 20 carbon atoms, for example methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, 2-hydroxyethyl, benzyl, 3-phenylpropyl, 2-cyanoethyl, 2-(methoxycarbonyl)ethyl, 2-(ethoxycarbonyl)ethyl, 2-(n-butoxycarbonyl)ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluoroisopentyl, 6-hydroxyhexyl and propylsulfonic acid;
glycols, butylene glycols and oligomers thereof having from 1 to 100 units and a hydrogen or a C₁-C₈-alkyl as end group, for example R^{A}O—(CHR^{B}—CH₂—O)ₘ—CHR^{B}—CH₂— or R^{A}O—(CH₂CH₂CH₂CH₂O)ₘ—CH₂CH₂CH₂CH₂— where R^{A} and R^{B} are each preferably hydrogen, methyl or ethyl and n is preferably 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxamidecyl and 3,6,9,12-tetraoxatetradecyl;
vinyl;
1-propen-1-yl, 1-propen-2-yl and 1-propen-3-yl; and
N,N-di-C₁-C₆-alkylamino, such as N,N-dimethylamino and N,N-diethylamino.

Very particular preference is given to the radicals R¹ to R⁹ each being, independently of one another, hydrogen or C₁-C₁₈-alkyl such as methyl, ethyl, 1-butyl, 1-pentyl, 1-hexyl, 1-heptyl, 1-octyl, phenyl, 2-hydroxyethyl, 2-cyanoethyl, 2-(methoxycarbonyl)ethyl, 2-(ethoxycarbonyl)ethyl, 2-(n-butoxycarbonyl)ethyl, N,N-dimethylamino, N,N-diethylamino, chlorine or CH₃O—(CH₂CH₂O)ₘ—CH₂CH₂— and CH₃CH₂O—(CH₂CH₂O)ₘ—CH₂CH₂— where m is 0-3.

Very particularly preferred pyridinium ions (IIIa) are those in which
one of the radicals R¹ to R⁵ is methyl, ethyl or chlorine and the remaining radicals R¹ to R⁵ are each hydrogen;
R³ is dimethylamino and the remaining radicals R¹, R², R⁴ and R⁵ are each hydrogen;
all radicals R¹ to R⁵ are hydrogen;
R² is carboxy or carboxamide and the remaining radicals R¹, R², R⁴ and R⁵ are each hydrogen; or
R¹ and R² or R² and R³ are 1,4-buta-1,3-dienylene and the remaining radicals R¹, R², R⁴ and R⁵ are each hydrogen;
   and in particular those in which
R¹ to R⁵ are each hydrogen; or
one of the radicals R¹ to R⁵ is methyl or ethyl and the remaining radicals R¹ to R⁵ are each hydrogen.

As very particularly preferred pyridinium ions (IIIa), mention may be made of 1-methylpyridinium, 1-ethylpyridinium, 1-(1-butyl)pyridinium, 1-(1-hexyl)pyridinium, 1-(1-octyl)pyridinium, 1-(1-hexyl)pyridinium, 1-(1-octyl)pyridinium, 1-(1-dodecyl)pyridinium, 1-(1-tetradecyl)pyridinium, 1-(1-hexadecyl)pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium and 1-(1-octyl)-2-methyl-3-ethylpyridinium, 1-(1-dodecyl)-2-methyl-3-ethylpyridinium, 1-(1-tetradecyl)-2-methyl-3-ethylpyridinium and 1-(1-hexadecyl)-2-methyl-3-ethylpyridinium. Very particularly preferred pyridazinium ions (IIIb) are those in which
R¹ bis R⁴ are each hydrogen; or
one of the radicals R¹ to R⁴ is methyl or ethyl and the remaining radicals R¹ to R⁴ are each hydrogen.

Very particularly preferred pyrimidinium ions (IIIc) are those in which
R¹ is hydrogen, methyl or ethyl and R² to R⁴ are each, independently of one another, hydrogen or methyl; or
R¹ is hydrogen, methyl or ethyl, R² and R⁴ are each methyl and R³ is hydrogen.

Very particularly preferred pyrazinium ions (IIId) are those in which
R¹ is hydrogen, methyl or ethyl and R² to R⁴ are each, independently of one another, hydrogen or methyl;
R¹ is hydrogen, methyl or ethyl, R² and R⁴ are each methyl and R³ is hydrogen;
R¹ to R⁴ are each methyl; or
R¹ to R⁴ are each methyl or hydrogen.

Very particularly preferred imidazolium ions (Ille) are those in which
R¹ is hydrogen, methyl, ethyl, 1-propyl, 1-butyl, 1-pentyl, 1-hexyl, 1-octyl, 1-propen-3-yl, 2-hydroxyethyl or 2-cyanoethyl, and R² to R⁴ are each, independently of one another, hydrogen, methyl or ethyl.

As very particularly preferred imidazolium ions (Ille), mention may be made of 1-methylimidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 1,4-dimethyl-3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium.

Very particularly preferred pyrazolium ions (IIIf), (IIIg) and (IIIg′) are those in which
R¹ is hydrogen, methyl or ethyl and R² to R⁴ are each, independently of one another, hydrogen or methyl.

Very particularly preferred pyrazolium ions (IIIh) are those in which
R¹ to R⁴ are each, independently of one another, hydrogen or methyl.

Very particularly preferred 1-pyrazolinium ions (IIIi) are those in which
R¹ to R⁶ are each, independently of one another, hydrogen or methyl.

Very particularly preferred 2-pyrazolinium ions (IIIj) and (IIIj′) are those in which
R¹ is hydrogen, methyl, ethyl or phenyl and R² to R⁶ are each, independently of one another, hydrogen or methyl.

Very particularly preferred 3-pyrazolinium ions (IIIk) and (IIIk′) are those in which
R¹ and R² are each, independently of one another, hydrogen, methyl, ethyl or phenyl and R³ to R⁶ are each, independently of one another, hydrogen or methyl.

Very particularly preferred imidazolinium ions (IIIl) are those in which
R¹ and R² are each, independently of one another, hydrogen, methyl, ethyl, 1-butyl or phenyl, R³ and R⁴ are each, independently of one another, hydrogen, methyl or ethyl and R⁵ and R⁶ are each, independently of one another, hydrogen or methyl.

Very particularly preferred imidazolinium ions (IIIm) and (IIIm′) are those in which
R¹ and R² are each, independently of one another, hydrogen, methyl or ethyl and R³ to R⁶ are each, independently of one another, hydrogen or methyl.

Very particularly preferred imidazolinium ions (IIIn) and (IIIn′) are those in which
R¹ to R³ are each, independently of one another, hydrogen, methyl or ethyl and R⁴ to R⁶ are each, independently of one another, hydrogen or methyl.

Very particularly preferred thiazolium ions (IIIo) and (IIIo′) and oxazolium ions (IIIp) are those in which
R¹ is hydrogen, methyl, ethyl or phenyl and R² and R³ are each, independently of one another, hydrogen or methyl.

Very particularly preferred 1,2,4-triazolium ions (IIIq), (IIIq′) and (IIIq″) are those in which
R¹ and R² are each, independently of one another, hydrogen, methyl, ethyl or phenyl and R³ is hydrogen, methyl or phenyl.

Very particularly preferred 1,2,3-triazolium ions (IIIr), (IIIr′) and (IIIr″) are those in which
R¹ is hydrogen, methyl or ethyl and R² and R³ are each, independently of one another, hydrogen or methyl or R² and R³ are together 1,4-buta-1,3-dienylene.

Very particularly preferred pyrrolidinium ions (IIIs) are those in which
R¹ is hydrogen, methyl, ethyl or phenyl and R² to R⁹ are each, independently of one another, hydrogen or methyl.

Very particularly preferred imidazolidinium ions (IIIt) are those in which
R¹ and R⁴ are each, independently of one another, hydrogen, methyl, ethyl or phenyl and R² and R³ and also R⁵ to R⁸ are each, independently of one another, hydrogen or methyl.

Very particularly preferred ammonium ions (IIIu) are those in which
R¹ to R³ are each, independently of one another, C₁-C₁₈-alkyl; or
R¹ and R² are together 1,5-pentylene or 3-oxa-1,5-pentylene and R³ is C₁-C₁₈-alkyl, 2-hydroxyethyl or 2-cyanoethyl.

As very particularly preferred ammonium ions (IIIu), mention may be made of methyltri(1-butyl)ammonium, N,N-dimethylpiperidinium and N,N-dimethylmorpholinium.

Examples of tertiary amines from which the quaternary ammonium ions of the general formula (IIIu) are derived by quaternization with the radicals R mentioned are diethyl-n-butylamine, diethyl-tert-butylamine, diethyl-n-pentylamine, diethyl-hexylamine, diethyloctylamine, diethyl(2-ethylhexyl)amine, di-n-propylbutylamine, di-n-propyl-n-pentylamine, di-n-propylhexylamine, di-n-propyloctylamine, di-n-propyl-(2-ethylhexyl)amine, diisopropylethylamine, diisopropyl-n-propylamine, diisopropylbutylamine, diisopropylpentylamine, diisopropylhexylamine, diisopropyloctylamine, diisopropyl(2-ethylhexyl)amine, di-n-butylethylamine, di-n-butyl-n-propylamine, di-n-butyl-n-pentylamine, di-n-butylhexylamine, di-n-butyloctylamine, di-n-butyl(2-ethylhexyl)amine, N-n-butylpyrrolidine, N-sec-butylpyrrolidine, N-tert-butylpyrrolidine, N-n-pentylpyrrolidine, N,N-dimethylcyclohexylamine, N,N-diethylcyclohexylamine, N,N-di-n-butylcyclohexylamine, N-n-propylpiperidine, N-isopropylpiperidine, N-n-butylpiperidine, N-sec-butylpiperidine, N-tert-butylpiperidine, N-n-pentylpiperidine, N-n-butylmorpholine, N-sec-butylmorpholine, N-tert-butylmorpholine, N-n-pentylmorpholine, N-benzyl-N-ethylaniline, N-benzyl-N-n-propylaniline, N-benzyl-N-isopropylaniline, N-benzyl-N-n-butylaniline, N,N-dimethyl-p-toluidine, N,N-diethyl-p-toluidine, N,N-di-n-butyl-p-toluidine, diethylbenzylamine, di-n-propylbenzylamine, di-n-butylbenzylamine, diethylphenylamine, di-n-propylphenylamine and di-n-butylphenylamine.

Preferred quaternary ammonium ions of the general formula (IIIu) are those which can be derived from the following tertiary amines by quaternization by means of the radicals R mentioned, e.g. diisopropylethylamine, diethyl-tert-butylamine, diisopropylbutylamine, di-n-butyl-n-pentylamine, N,N-di-n-butylcyclohexylamine and tertiary amines derived from pentyl isomers.

Particularly preferred tertiary amines are di-n-butyl-n-pentylamine and tertiary amines derived from pentyl isomers. A further preferred tertiary amine which has three identical radicals is triallylamine.

Very particularly preferred guanidinium ions (IIIv) are those in which
R¹ to R⁵ are each methyl.

As a very particularly preferred guanidinium ion (IIIv) mention may be made of N,N,N′,N′,N″,N″-hexamethylguanidinium.

Very particularly preferred cholinium ions (IIIw) are those in which
R¹ and R² are each, independently of one another, methyl, ethyl, 1-butyl or 1-octyl and R³ is hydrogen, methyl, ethyl, acetyl —SO₂OH or —PO(OH)₂;
R¹ is methyl, ethyl, 1-butyl or 1-octyl, R² is a —CH₂—CH₂—OR⁴ group and R³ and R⁴ are each, independently of one another, hydrogen, methyl, ethyl, acetyl —SO₂OH or —PO(OH)₂; or
R¹ is a —CH₂—CH₂—OR⁴ group, R² is a —CH₂—CH₂—OR⁵ group and R³ to R⁵ are each, independently of one another, hydrogen, methyl, ethyl, acetyl —SO₂OH or —PO(OH)₂.

Particularly preferred cholinium ions (IIIw) are those in which R³ is selected from among, hydrogen, methyl, ethyl, acetyl, 5-methoxy-3-oxapentyl, 8-methoxy-3,6-dioxaoctyl, 1′-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl and 14-ethoxy-5,10-oxatetradecyl.

Very particularly preferred phosphonium ions (IIIx) are those in which
R¹ to R³ are each, independently of one another, C₁-C₁₈-alkyl, in particular butyl, isobutyl, 1-hexyl or 1-octyl.

Among the abovementioned heterocyclic cations, preference is given to the pyridinium ions, pyrazolinium ions, pyrazolium ions and the imidazolinium ions and the imidazolium ions. Preference is also given to ammonium ions.

Particular preference is given to 1-methylpyridinium, 1-ethylpyridinium, 1-(1-butyl)pyridinium, 1-(1-hexyl)pyridinium, 1-(1-octyl)pyridinium, 1-(1-hexyl)pyridinium, 1-(1-octyl)pyridinium, 1-(1-dodecyl)pyridinium, 1-(1-tetradecyl)pyridinium, 1-(1-hexadecyl)pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium, 1-(1-octyl)-2-methyl-3-ethylpyridinium, 1-(1-dodecyl)-2-methyl-3-ethylpyridinium, 1-(1-tetradecyl)-2-methyl-3-ethylpyridinium, 1-(1-hexadecyl)-2-methyl-3-ethylpyridinium, 1-methylimidazolium, 1-ethylimidazolium, 1-(1-butyl)-imidazolium, 1-(1-octyl)-imidazolium, 1-(1-dodecyl)imidazolium, 1-(1-tetradecyl)-imidazolium, 1-(1-hexadecyl)imidazolium, 1,3-dimethylimidazolium, 1-ethyl-3-methylimidazolium, 1-(1-butyl)-3-methylimidazolium, 1-(1-hexyl)-3-methylimidazolium, 1-(1-octyl)-3-methylimidazolium, 1-(1-dodecyl)-3-methylimidazolium, 1-(1-tetradecyl)-3-methylimidazolium, 1-(1-hexadecyl)-3-methylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium and 1-(1-octyl)-2,3-dimethylimidazolium, 1,4-dimethylimidazolium, 1,3,4-trimethylimidazolium, 1,4-dimethyl-3-ethylimidazolium, 3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium.

As anions, it is in principle possible to use all anions.

The anion [Y]ⁿ⁻ of the ionic liquid is, for example, selected from among
the group of halides of the formulae:
   F—, Cl—, Br—, I—
the group of halogen-comprising compounds and pseudohalides of the formulae:
   BF₄—, PF₆—, CF₃SO₃—, (CF₃SO₃)₂N—, CF₃CO₃CO₃—, CCl₃CO₂—, CN—, SCN—, OCN—
the group of sulfates, sulfites and sulfonates of the general formulae:
   SO₄²—, HSO₄—, SO₃²—, HSO₃—, R^{a}OSO₃—, R^{a}SO₃—
the group of phosphates of the general formulae:
   PO₄³—, HPO₄²—, H₂PO₄—, R^{a}PO₄²—, HR^{a}PO₄—, R^{a}R^{b}PO₄—
the group of phosphonates and phosphinates of the general formulae:
   R^{a}HPO₃—, R^{a}R^{b}PO₂—, R^{a}R^{b}PO₃—
the group of phosphites of the general formulae:
   PO₃³—, HPO₃²—, H₂PO₃—, R^{a}PO₃²—, R^{a}HPO₃—, R^{a}R^{b}PO₃—
the group of phosphonites and phosphinites of the general formulae:
   R^{a}R^{b}PO₂—, R^{a}HPO₂—, R^{a}R^{b}PO, R^{a}HPO—
the group of carboxylic acids of the general formula:
   R^{a}COO—
the group of borates of the general formulae:
   BO₃³—, HBO₃²—, H₂BO₃—, R^{a}R^{b}BO₃—, R^{a}HBO₃—, R^{a}BO₃²—, B(OR^{a})(OR^{b})(OR^{c})(OR^{d})—, B(HSO₄)—, B(R^{a}SO₄)—
the group of boronates of the general formulae:
   R^{a}BO₂²—, R^{a}R^{b}BO—
the group of silicates and silicic esters of the general formulae:
   SiO₄⁴—, HSiO₄³—, H₂SiO₄²—, H₃SiO₄—, R^{a}SiO₄³—, R^{a}R^{b}SiO₄²—, R^{a}R^{b}R^{c}SiO₄—, HR^{a}SiO₄²—, H₂R^{a}SiO₄—, HR^{a}R^{b}SiO₄—
the group of alkylsilane and arylsilane salts of the general formulae:
   R^{a}SiO₃³—, R^{a}R^{b}SiO₂²—, R^{a}R^{b}R^{c}SiO—, R^{a}R^{b}R^{c}SiO₃—, R^{a}R^{b}R^{c}SiO₂—, R^{a}R^{b}SiO₃²—
the group of carboximides, bis(sulfonyl)imides and sulfonylimides of the general formulae:

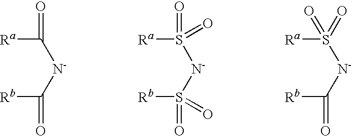

the group of methides of the general formula:

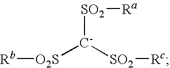

Here, R^{a}, R^{b}, R^{c} and R^{d} are each, independently of one another, hydrogen, C₁-C₃₀-alkyl, C₂-C₁₈-alkyl which may optionally be interrupted by one or more nonadjacent oxygen and/or sulfur atoms and/or one or more substituted or unsubstituted imino groups, C₆-C₁₄-aryl, C₅-C₁₂-cycloalkyl or a five- or six-membered, oxygen-, nitrogen- and/or sulfur-comprising heterocycle, where two of them may also together form an unsaturated, saturated or aromatic ring which may optionally be interrupted by one or more oxygen and/or sulfur atoms and/or one or more unsubstituted or substituted imino groups, where the radicals mentioned may each be additionally substituted by functional groups, aryl, alkyl, aryloxy, alkyloxy, halogen, heteroatoms and/or heterocycles.

Here, C₁-C₁₈-alkyl which may optionally be substituted by functional groups, aryl, alkyl, aryloxy, alkyloxy, halogen, heteroatoms and/or heterocycles is, for example, methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, heptadecyl, octadecyl, 1,1-dimethylpropyl, 1,1-dimethylbutyl, 1,1,3,3-tetramethylbutyl, benzyl, 1-phenylethyl, α,α-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-hydroxyethyl, 2-hydroxypropyl, 3-hydroxypropyl, 4-hydroxybutyl, 6-hydroxyhexyl, 2-aminoethyl, 2-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl.

C₂-C₁₈-alkyl which may optionally be interrupted by one or more nonadjacent oxygen and/or sulfur atoms and/or one or more substituted or unsubstituted imino groups is, for example, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

If two radicals form a ring, these radicals can together form as fused-on building block, for example, 1,3-propylene, 1,4-butylene, 2-oxa-1,3-propylene, 1-oxa-1,3-propylene, 2-oxa-1,3-propenylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

The number of nonadjacent oxygen and/or sulfur atoms and/or imino groups is in principle not subject to any restrictions or is automatically restricted by the size of the radical or the cyclic building block. In general, there will be no more than 5 in the respective radical, preferably no more than 4 and very particularly preferably no more than 3. Furthermore, there is generally at least one carbon atom, preferably at least two carbon atoms, between any two heteroatoms.

Substituted and unsubstituted imino groups can be, for example, imino, methylimino, isopropylimino, n-butylimino or tert-butylimino.

The term “functional groups” refers, for example, to the following: carboxy, carboxamide, di-(C₁-C₄-alkyl)amino, C₁-C₄-alkyloxycarbonyl, cyano or C₁-C₄-alkoxy. Here, C₁-C₄-alkyl is methyl, ethyl, propyl, isopropyl, n-butyl, sec-butyl or tert-butyl.

C₆-C₁₄-aryl which may optionally be substituted by functional groups, aryl, alkyl, aryloxy, alkyloxy, halogen, heteroatoms and/or heterocycles is, for example, phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl.

C₅-C₁₂-cycloalkyl which may optionally be substituted by functional groups, aryl, alkyl, aryloxy, halogen, heteroatoms and/or heterocycles is, for example, cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl or a saturated or unsaturated bicyclic system such as norbornyl or norbornenyl.

A five- or six-membered, oxygen-, nitrogen- and/or sulfur-comprising heterocycle is, for example, furyl, thiophenyl, pyrryl, pyridyl, indolyl, benzoxazolyl, dioxolyl, dioxyl, benzimidazolyl, benzthiazolyl, dimethylpyridyl, methylquinolyl, dimethylpyrryl, methoxyfuryl, dimethoxypyridyl, difluoropyridyl, methylthiophenyl, isopropylthiophenyl or tert-butylthiophenyl.

Preferred anions are selected from the group of halides, the group of halogen-comprising compounds and pseudohalides, the group of sulfates, sulfites and sulfonates, the group of phosphates and the group of carboxylic acids, in particular from the group of halides, the group of halogen-comprising compounds and pseudohalogens, the group of carboxylic acids, the group consisting of SO₄²—, SO₃²—, R^{a}OSO₃— and R^{a}SO₃— and the group consisting of PO₄³— and R^{a}R^{b}PO₄—.

Preferred anions are, in particular, chloride, bromide, iodide, SCN—, OCN—, CN—, acetate, propionate, benzoate, C₁-C₄-alkylsulfates, R^{a}—COO—, R^{a}SO₃—, R^{a}R^{b}PO₄—, methanesulfonate, tosylate or di(C₁-C₄-alkyl)phosphates.

Particularly preferred anions are Cl—, CH₃COO—, C₂H₅COO—, C₆H₅COO—, CH₃SO₃—, (CH₃O)₂PO₂— and (C₂H₅O)₂PO₂—.

In a further preferred embodiment, ionic liquids of the formula I in which
[A]ₙ⁺ is 1-methylimidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 1,4-dimethyl-3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium; and
[Y]ₙ⁺ is Cl—, CH₃COO—, C₂H₅COO—, C₆H₅COO—, CH₃SO₃—, (CH₃O)₂PO₂— or (C₂H₅O)₂PO₂—;
   are used.

In a further particularly preferred embodiment, ionic liquids whose anions are selected from the group of halogen-comprising compounds and pseudohalogens, the group of sulfates, sulfites and sulfonates, the group of phosphates and the group of carboxylic acids, in particular from the group of carboxylic acids, the group consisting of SO₄²—, SO₃²—, R^{a}OSO₃— and R^{a}SO₃—, and the group consisting of PO₄³— and R^{a}R^{b}PO₄— are used.

Preferred anions are, in particular, SCN—, OCN—, CN—, acetate, propionate, benzoate, C₁-C₄-alkylsulfates, R^{a}—COO—, R^{a}SO₃—, R^{a}R^{b}PO₄—, methanesulfonate, tosylate or di-(C₁-C₄-alkyl)phosphates.

Particularly preferred anions are CH₃COO—, C₂H₅COO—, C₆H₅COO—, CH₃SO₃—, (CH₃O)₂PO₂— or (C₂H₅O)₂PO₂—.

In a further particularly preferred embodiment, ionic liquids of the formula I in which
[A]ₙ⁺ is 1-methylimidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 1,4-dimethyl-3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium; and
[Y]ₙ⁺ is CH₃COO—, C₂H₅COO—, C₆H₅COO—, CH₃SO₃—, (CH₃O)₂PO₂— or (C₂H₅O)₂PO₂—;
   are used.

In a further particularly preferred embodiment, ionic liquids whose anions are selected from the group of halides are used.

A preferred anion is, in particular, chloride.

In a further particularly preferred embodiment, ionic liquids of the formula I in which
[A]ₙ⁺ is 1-methylimidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 1,4-dimethyl-3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium; and
[Y]ₙ⁺ is Cl—;
   are used.

In a further preferred embodiment, ionic liquids whose anions are selected from the group consisting of HSO₄—, HPO₄²—, H₂PO₄— and HR^{a}PO₄—, in particular HSO₄—, are used.

In particular, ionic liquids of the formula I in which
[A]ₙ⁺ is 1-methylimidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 1,4-dimethyl-3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium or 1-(prop-1-en-3-yl)-3-methylimidazolium; and
[Y]ₙ+is HSO₄—;
   are used.

In the process of the invention, use is made of one ionic liquid of the formula I or a mixture of ionic liquids of the formula I. Preference is given to using one ionic liquid of the formula I.

In a further embodiment of the invention, it is possible to use one ionic liquid of the formula II or a mixture of ionic liquids of the formula II. Preference is given to using one ionic liquid of the formula II.

In a further embodiment of the invention, it is possible to use a mixture of ionic liquids of the formulae I and II.

In step A) of the process of the invention, the targeted degradation of the cellulose is carried out in the presence of an acid, if appropriate with addition of water, (step A1) or at elevated temperature, if appropriate in the presence of water (step A2).

In step A1, it is possible to use inorganic acids, organic acids or mixtures thereof as acids.

Examples of inorganic acids are hydrohalic acids such as HF, HCl, HBr or HI, perhalic acids such as HClO₄, halic acids such as HClO₃, sulfur-comprising acids such as H₂SO₄, polysulfuric acid or H₂SO₃ nitrogen-comprising acids such as HNO₃ or phosphorus-comprising acids such as H₃PO₄, polyphosphoric acid or H₃PO₃. Preference is given to using hydrohalic acids such as HCl or HBr, H₂SO₄, HNO₃ or H₃PO₄, in particular HCl, H₂SO₄ or H₃PO₄.

Examples of organic acids are carboxylic acids such as
C₁-C₆-alkanecarboxylic acids, for example acetic acid, propionic acid, n-butanecarboxylic acid or pivalic acid,
dicarboxylic or polycarboxylic acids, for example succinic acid, maleic acid or fumaric acid,
hydroxycarboxylic acids, for example hydroxyacetic acid, lactic acid, malic acid or citric acid,
halogenated carboxylic acids, for example C₁-C₆-haloalkanecarboxylic acids, e.g. fluoroacetic acid, chloroacetic acid, bromoacetic acid, difluoroacetic acid, dichloroacetic acid, chlorofluoroacetic acid, trifluoroacetic acid, trichloroacetic acid, 2-chloropropionic acid, perfluoropropionic acid or perfluorobutanecarboxylic acid,
aromatic carboxylic acids, for example arylcarboxylic acids such as benzoic acid;
   and sulfonic acids such as
C₁-C₆-alkanesulfonic acids, for example methanesulfonic acid or ethanesulfonic acid,
halogenated sulfonic acids, for example C₁-C₆-haloalkanesulfonic acids such as trifluoromethanesulfonic acid;
aromatic sulfonic acids, for example arylsulfonic acids such as benzenesulfonic acid or 4-methylphenylsulfonic acid.

As organic acids, preference is given to using C₁-C₆-alkanecarboxylic acids, for example acetic acid or propionic acid, halogenated carboxylic acids, for example C₁-C₆-haloalkanecarboxylic acids, e.g. fluoroacetic acid, chloroacetic acid, difluoroacetic acid, dichloroacetic acid, chlorofluoroacetic acid, trifluoroacetic acid, trichloroacetic acid, or perfluoropropionic acid, or sulfonic acids such as C₁-C₆-alkanesulfonic acids, for example methanesulfonic acid or ethanesulfonic acid, halogenated sulfonic acids, for example C₁-C₆-haloalkanesulfonic acids such as trifluoromethanesulfonic acid, or arylsulfonic acids such as benzenesulfonic acid or 4-methylphenylsulfonic acid. Preference is given to using acetic acid, chlorofluoroacetic acid, trifluoroacetic acid, perfluoropropionic acid, methanesulfonic acid, trifluoromethanesulfonic acid or 4-methylphenylsulfonic acid.

In a particular embodiment of the invention, sulfuric acid, acetic acid, trifluoroacetic acid, methanesulfonic acid or 4-methylphenylsulfonic acid is used as acid. When 4-methylphenylsulfonic acid monohydrate is used, one equivalent of water is already present.

In a particular embodiment, ionic liquids and acids whose anions are identical are used. These anions are preferably acetate, trifluoracetate, chloride or bromide, particularly preferably acetate, likewise particularly preferably chloride.

In a further particular embodiment, ionic liquids and acids whose anions are not identical are used.

In step B, acylating agents are used. For the purposes of the present invention, acylating agents are carboxylic acid derivatives and also ketenes and diketenes.

For the purposes of the present invention, carboxylic acid derivatives are carboxylic acid derivatives of the formula IV

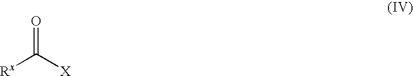

where the radicals have the following meanings:
R^{x}, R^{x′} are each H, C₁-C₃₀-alkyl, C₂-C₃₀-alkenyl, C₂-C₃₀-alkynyl, C₃-C₁₂-cycloalkyl, C₅-C₁₂-cycloalkenyl, aryl or heterocyclyl, where these seven last-named radicals may optionally be substituted;
X is halogen, imidazol-1-yl or O—COR^{x′}.

For the purposes of the present invention, ketenes (compounds of the formula V) are ketenes of the formula Va and, for the purposes of the present invention, diketenes are diketenes of the formula Vb1 or mixed diketenes of the formula Vb2,

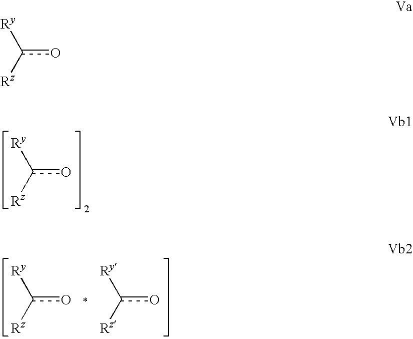

where the radicals have the following meanings:
R^{y}, R^{y′}, R^{z}, R^{z′} are each hydrogen, C₁-C₃₀-alkyl, C₂-C₃₀-alkenyl, C₂-C₃₀-alkynyl, C₃-C₁₂-cycloalkyl, C₅-C₁₂-cycloalkenyl, aryl or heterocyclyl, where the seven last-named radicals may optionally be substituted;
or
R^{y} and R^{z} or R^{y′} and R^{z′} together form an optionally substituted —Yₒ—(CH₂)ₚ—, —(CH₂)_{q}—Y—(CH₂)ᵣ— or a —CH═CH—CH═CH— chain, where
   Y is O, S, S(═O), S(═O)₂, NH or NC₁-C₆-alkyl;
   o is 0 or 1;
   p is 2, 3, 4, 5, 6, 7 or 8;
   q, r are each 1, 2, 3, 4, 5 or 6.

Optionally substituted C₁-C₃₀-alkyl radicals R^{x}, R^{x′}, R^{y}, R^{y′}, R^{z} and R^{z′} are, in particular, unsubstituted C₁-C₃₀-alkyl radicals or C₁-C₃₀-alkyl radicals substituted by functional groups, aryl, alkyl, aryloxy, alkyloxy, cycloalkyl, halogen, heteroatoms and/or heterocycles,

preferably C₁-C₃₀-alkyl radicals, for example methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, 2-ethylhexyl, 2,4,4-trimethylpentyl, 1,1,3,3-tetramethylbutyl, 1-nonyl, 1-decyl, 1-undecyl, 1-dodecyl, 1-tridecyl, 1-tetradecyl, 1-pentadecyl, 1-hexadecyl, 1-heptadecyl, 1-octadecyl and 1-eicosanyl, particularly preferably methyl, ethyl, 1-propyl, 1-butyl, 1-decyl, 1-dodecyl, 1-tetradecyl or 1-hexadecyl;
or
preferably C₁-C₃₀-alkyl radicals substituted by functional groups, aryl, alkyl, aryloxy, alkyloxy, cycloalkyl, halogen, heteroatoms and/or heterocycles, for example cyanomethyl, 2-cyanoethyl, 2-cyanopropyl, methoxycarbonylmethyl, 2-methoxycarbonylethyl, ethoxycarbonylmethyl, 2-ethoxycarbonylethyl, 2-(butoxycarbonyl)ethyl, 2-butoxycarbonylpropyl, 1,2-di(methoxycarbonyl)ethyl, formyl, hydroxymethyl, 2-hydroxyethyl, 2-hydroxypropyl, 3-hydroxypropyl, 4-hydroxybutyl, 6-hydroxyhexyl, 2-hydroxy-2,2-dimethylethyl, aminomethyl, 2-aminoethyl, 2-aminopropyl, 3-aminopropyl, 4-aminobutyl, 6-aminohexyl, methylaminomethyl, 2-methylaminoethyl, 2-methylaminopropyl, 3-methylaminopropyl, 4-methylaminobutyl, 6-methylaminohexyl, dimethylaminomethyl, 2-dimethylaminoethyl, 2-dimethylaminopropyl, 3-dimethylaminopropyl, 4-dimethylaminobutyl, 6-dimethylaminohexyl, phenoxymethyl, 2-phenoxyethyl, 2-phenoxypropyl, 3-phenoxypropyl, 4-phenoxybutyl, 6-phenoxyhexyl, methoxymethyl, 2-methoxyethyl, 2-methoxypropyl, 3-methoxypropyl, 4-methoxybutyl, 6-methoxyhexyl, ethoxymethyl, 2-ethoxyethyl, 2-ethoxypropyl, 3-ethoxypropyl, 4-ethoxybutyl, 6-ethoxyhexyl, 2-butoxyethyl, 2-isopropoxyethyl, 2-butoxypropyl, 2-octyloxyethyl, 2-methoxyisopropyl, dimethoxymethyl, diethoxymethyl, 2,2-diethoxymethyl, 2,2-diethoxyethyl, acetyl, propionyl, CₘF_{2(m-a)+(1-b)}H_{2a+b} where m is from 1 to 30, 0≦a≦m and b=0 or 1 (for example CF₃, C₂F₅, CH₂CH₂—C₍ₘ₋₂₎F₂₍ₘ₋₂₎₊₁, C₆F₁₃, C₈F₁₇, C₁₀F₂₁, C₁₂F₂₅), chloromethyl, 2-chloroethyl, trichloromethyl, 1,1-dimethyl-2-chloroethyl, methylthiomethyl, ethylthiomethyl, butylthiomethyl, 2-dodecylthioethyl, 2-phenylthioethyl, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-dioxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-dioxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

Optionally substituted C₂-C₃₀-alkenyl radicals R^{x}, R^{x1}, R^{y}, R^{y1}, R^{z} and R^{z1} are, in particular, unsubstituted C₂-C₃₀-alkenyl radicals or C₂-C₃₀-alkenyl radicals substituted by functional groups, aryl, alkyl, aryloxy, alkyloxy, cycloalkyl, halogen, heteroatoms and/or heterocycles,

preferably C₂-C₃₀-alkenyl radicals, for example vinyl, 2-propenyl, 3-butenyl, cis-2-butenyl or trans-2-butenyl, particularly preferably vinyl or 2-propenyl;
or
preferably C₂-C₃₀-alkenyl radicals substituted by functional groups, aryl, alkyl, aryloxy, alkyloxy, cycloalkyl, halogen, heteroatoms and/or heterocycles, for example CₘF_{2(m-a)-(1-b)}H_{2a-b} where m≦30, 0≦a≦m and b=0 or 1.

Optionally substituted C₂-C₃₀-alkynyl radicals R^{x}, R^{x′}, R^{y}, R^{y′}, R^{z} and R^{z′} are, in particular, unsubstituted C₂-C₃₀-alkynyl radicals or C₂-C₃₀-alkynyl radicals substituted by functional groups, aryl, alkyl, aryloxy, alkyloxy, cycloalkyl, halogen, heteroatoms and/or heterocycles,

preferably C₂-C₃₀-alkynyl radicals such as ethynyl, 1-propyn-3-yl, 1-propyn-1-yl or 3-methyl-1-propyn-3-yl, particularly preferably ethynyl or 1-propyn-3-yl.

Optionally substituted C₃-C₁₂-cycloalkyl radicals R^{x}, R^{x′}, R^{y}, R^{y′}, R^{z} and R^{z′} are, in particular, unsubstituted C₃-C₈-cycloalkyl radicals or C₃-C₁₂-cycloalkyl radicals substituted by functional groups, aryl, alkyl, aryloxy, alkyloxy, cycloalkyl, halogen, heteroatoms and/or heterocycles,

preferably C₃-C₁₂-cycloalkyl radicals, for example cyclopropyl, cyclobutyl, cyclopentyl, cyclohexyl, cyclooctyl, cyclododecyl, methylcyclopentyl, dimethylcyclopentyl, methylcyclohexyl, dimethylcyclohexyl, diethylcyclohexyl or butylcyclohexyl, and also bicyclic systems such as norbornyl, preferably cyclopentyl or cyclohexyl;
or
preferably C₃-C₁₂-cycloalkyl radicals substituted by functional groups, aryl, alkyl, aryloxy, alkyloxy, cycloalkyl, halogen, heteroatoms and/or heterocycles, for example methoxycyclohexyl, dimethoxycyclohexyl, diethoxycyclohexyl, butylthiocyclohexyl, chlorocyclohexyl, dichlorocyclohexyl, dichlorocyclopentyl, CₘF_{2(m-a)-(1-b)}H_{2a-b} where m≦30, 0≦a≦m and b=0 or 1.

Optionally substituted C₅-C₁₂-cycloalkenyl radicals R^{x}, R^{x′}, R^{y}, R^{y′}, R^{z} and R^{z′} are, in particular unsubstituted C₃-C₈-cycloalkenyl radicals or C₃-C₈-cycloalkenyl radicals substituted by functional groups, aryl, alkyl, aryloxy, alkyloxy, cycloalkyl, halogen, heteroatoms and/or heterocycles,

preferably C₃-C₈-cycloalkenyl radicals, for example 3-cyclopentenyl, 2-cyclohexenyl, 3-cyclohexenyl, 2,5-cyclohexadienyl, and also bicyclic systems such as norbornyl, particularly preferably 3-cyclopentenyl, 2-cyclohexenyl or 3-cyclohexenyl;
or
preferably C₃-C₈-cycloalkenyl radicals substituted by functional groups, aryl, alkyl, aryloxy, alkyloxy, cycloalkyl, halogen, heteroatoms and/or heterocycles, for example CₙF_{2(m-a)-3(1-b)}H_{2a-3b} where m≦12, 0≦a≦m and b=0 or 1.

Optionally substituted aryl radicals R^{x}, R^{x′}, R^{y}, R^{y′}, R^{z} and R^{z′} are, in particular, unsubstituted C₆-C₁₂-aryl radicals or C₆-C₁₂-aryl radicals substituted by functional groups, aryl, alkyl, aryloxy, alkyloxy, cycloalkyl, halogen, heteroatoms and/or heterocycles,

preferably C₆-C₁₂-aryl radicals, for example phenyl, α-naphthyl or β-naphthyl, particularly preferably phenyl;
or
preferably C₆-C₁₂-aryl radicals substituted by functional groups, aryl, alkyl, aryloxy, alkyloxy, cycloalkyl, halogen, heteroatoms and/or heterocycles, e.g. tolyl, xylyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2-nitrophenyl, 4-nitrophenyl, 2,4-dinitrophenyl, 2,6-dinitrophenyl, 4-dimethylaminophenyl, 4-acetylphenyl, methoxyethylphenyl, ethoxymethylphenyl, methylthiophenyl, isopropylthiophenyl or tert-butylthiophenyl or C₆F₍₅₋ₐ₎Hₐ where 0≦a≦5, particularly preferably 4-tolyl.

Optionally substituted heterocyclyl radicals are, in particular, unsubstituted heteroaryl radicals or heteroaryl radicals substituted by functional groups, aryl, alkyl, aryloxy, alkyloxy, cycloalkyl, halogen, heteroatoms and/or heterocycles,

preferably 5- or 6-membered heteroaryl radicals comprising oxygen, nitrogen and/or sulfur atoms, e.g. furyl, thiophenyl, pyrryl, pyridyl, indolyl, benzoxazolyl, dioxolyl, dioxyl, benzimidazolyl or benzthiazolyl;
or
preferably 5- or 6-membered heteroaryl radicals which comprise oxygen, nitrogen and/or sulfur atoms and are substituted by functional groups, aryl, alkyl, aryloxy, alkyloxy, cycloalkyl, halogen, heteroatoms and/or heterocycles, e.g. methylpyridyl, dimethylpyridyl, methylquinolyl, dimethylpyrryl, methoxyfuryl, dimethoxypyridyl, chloropyridyl or difluoropyridyl.

If R^{y} and R^{z} or R^{y′} and R^{z′} together form an optionally substituted —Yₒ—(CH₂)ₚ—, —(CH₂)_{q}—Y—(CH₂)ᵣ— or a —CH═CH—CH═CH— chain, preference is given to a —Yₒ—(CH₂)ₚ—, (CH₂)_{q}—Y—(CH₂)ᵣ— or —CH═CH—CH═CH— chain, particularly preferably —(CH₂)₅—, —(CH₂)₆— or —CH═CH—CH═CH—, in particular —(CH₂)₅— or —(CH₂)₆—,

or
a C₁-C₄-alkyl-substituted —Yₒ—(CH₂)ₚ—, —(CH₂)_{q}—Y—(CH₂), or —CH═CH—CH═CH— chain substituted by C₁-C₄-alkyl.

In an embodiment of the present invention, carboxylic acid derivatives of the formula IV are used.

In particular, carboxylic acid derivatives of the formula IV in which the radicals have the following meanings:
R^{x}, R^{x′} is hydrogen or C₁-C₃₀-alkyl;
X is halogen or O—COR^{x′},
   are used.

Particular preference is given to using carboxylic acid derivatives of the formula IV in which the radicals have the following meanings:
R^{x} is hydrogen or C₁-C₁₈-alkyl, preferably hydrogen or C₁-C₆-alkyl; particularly preferably methyl, ethyl or butyl;
X is halogen, preferably chloride.

Particular preference is likewise given to using carboxylic acid derivatives of the formula IV in which the radicals have the following meanings:
R^{x} is 1-decyl, 1-dodecyl, 1-tetradecyl or 1-hexadecyl;
X is halogen, preferably chloride.

Particular preference is given to using carboxylic acid derivatives of the formula IV in which the radicals have the following meanings:
R^{x}, R^{x′} are each hydrogen or C₁-C₁₈-alkyl, preferably hydrogen or C₁-C₆-alkyl; particularly preferably methyl, ethyl or butyl;
X is OCOR^{x′}.

Extraordinary preference is given to using carboxylic acid derivatives of the formula IV in which the radicals R^{x} and R^{x′} have the same meanings (“symmetrical carboxylic anhydrides”).

Particular preference is likewise given to using carboxylic acid derivatives of the formula IV in which the radicals have the following meanings:
R^{x} is 1-decyl, 1-dodecyl, 1-tetradecyl or 1-hexadecyl;
X is OCOR^{x}.

Extraordinary preference is given to using carboxylic acid derivatives of the formula IV in which the radicals R^{x} and R^{x′} have the same meanings (“symmetrical carboxylic anhydrides”).

In a further embodiment of the present invention, ketenes of the formula Va are used.

In particular, ketenes of the formula Va in which the radicals have the following meanings:
R^{y} is hydrogen or C₁-C₁₈-alkyl, preferably hydrogen or C₁-C₆-alkyl; particularly preferably hydrogen, methyl or ethyl; extraordinarily preferably hydrogen;
R^{z} is hydrogen,
   are used.

Particular preference is likewise given to using ketenes of the formula Va in which the radicals have the following meanings:
R^{y} is 1-decyl, 1-dodecyl, 1-tetradecyl or 1-hexadecyl;
R^{z} is hydrogen.

In a further embodiment of the present invention, diketenes of the formula Vb1 are used.

In particular, diketenes of the formula Vb1 in which the radicals have the following meanings:
R^{y} is hydrogen or C₁-C₁₈-alkyl, preferably hydrogen or C₁-C₆-alkyl, particularly preferably hydrogen, methyl or ethyl, in particular hydrogen;
R^{z} is hydrogen,
   are used.

Particular preference is likewise given to using diketenes of the formula Vb1 in which the radicals have the following meanings:
R^{y} is 1-decyl, 1-dodecyl, 1-tetradecyl or 1-hexadecyl;
R^{z} is hydrogen.

In a further embodiment of the present invention, mixed diketenes of the formula Vb2 are used.

In particular, mixed deketenes of the formula Vb2 in which the radicals have the following meanings:
R^{y}, R^{y′} are each hydrogen or C₁-C₆-alkyl, preferably hydrogen, methyl or ethyl, in particular hydrogen;
R^{z}, R^{z′} are each hydrogen,
   are used.

Particular preference is likewise given to using diketenes of the formula Vb2 in which the radicals have the following meanings:
R^{y}, R^{y′} are each 1-decyl, 1-dodecyl, 1-tetradecyl or 1-hexadecyl
R^{z}, R^{z′} are each hydrogen.

For the process of the invention, it is possible to use celluloses from a wide variety of sources, e.g. from cotton, flax, ramie, straw, bacteria, etc. or from wood or bagasse, in the cellulose-enriched form.

However, the process of the invention can not only be carried out using cellulose but also a polysaccharide or oligosaccharide in general. Examples of polysaccharides include cellulose and hemicellulose and also starch, glycogen, dextran and tunicin. Further examples are the polycondensates of D-fructose, e.g. inulin, and also, inter alia, chitin, and alginic acid. The corresponding statements apply analogously here.

In one embodiment of the present invention, a polysaccharide such as cellulose, hemicellulose, starch, glycogen, dextran, tunicin, inulin, chitin or alginic acid, preferably cellulose, is reacted according to the process of the invention. In the process of the invention, a solution of cellulose in an ionic liquid is prepared. The concentration of cellulose here can be varied within a wide range. It is usually in the range from 0.1 to 50% by weight, based on the total weight of the solution, preferably from 0.2 to 40% by weight, particularly preferably from 0.3 to 30% by weight and very particularly preferably from 0.5 to 20% by weight.

This dissolution procedure can be carried out at room temperature or with heating, but above the melting point or softening temperature of the ionic liquid, usually at a temperature of from 0 to 200° C., preferably from 20 to 180° C., particularly preferably from 50 to 150° C. However, it is also possible to accelerate dissolution by intensive stirring or mixing or by introduction of microwave or ultrasonic energy or by a combination of these.

This solution is then used in step A1) or in step A2).

In step A1) according to the invention, the targeted degradation is carried out in the presence of an acid, if appropriate with addition of water.

As acids, use is made of inorganic acids, organic acids or mixtures thereof, as described above.

In a particular embodiment, ionic liquids and acids whose anions are identical are used. These anions are preferably acetic, trifluoroacetate, chloride or bromide.

In a further particular embodiment, ionic liquids and acids whose anions are not identical are used.

As described above, the cellulose is dissolved in the ionic liquid. The acid and if appropriate water are added to the solution obtained in this way. The addition of water can be necessary when the water adhering to the cellulose used is not sufficient to achieve the desired degree of degradation. In general, the water content of normal cellulose is in the range from 5 to 10% by weight, based on the total weight of the cellulose used (cellulose per se+adhering water). For partial degradation of the cellulose, the amounts of water and acid which are stoichiometrically necessary to achieve an appropriate DP are added. However, it is also possible to use an excess of water and acid and to stop the reaction when the desired degree of degradation has been reached.

In another embodiment, the ionic liquid, acid and, if appropriate, water are premixed and the cellulose is dissolved in this mixture.

It is also possible for one or more further solvents to be added to the reaction mixture or to be added together with the ionic liquid and/or the acid and/or, if appropriate, the water. Possible solvents here are ones which do not adversely affect the solubility of the cellulose, e.g. aprotic dipolar solvents, for example dimethyl sulfoxide, dimethylformamide, dimethylacetamide or sulfolane.

In a particular embodiment, the reaction mixture comprises less than 5% by weight, preferably less than 2% by weight, in particular less than 0-1% by weight, of further solvent, based on the total weight of the reaction mixture.

Depending on the ionic liquid used and the acid used, the hydrolysis is usually carried out at a temperature from the melting point of the ionic liquid to 200° C., preferably from 20 to 180° C., in particular from 50 to 150° C.

The reaction is usually carried out at ambient pressure. However, it can sometimes also be advantageous to carry it out under superatmospheric pressure, particularly when volatile acids are used.

In general, the reaction is carried out in air. However, it is also possible to carry it out under inert gas, i.e., for example, under N₂, a noble gas or a mixture thereof.

The amount of acid used, the water added if appropriate, in each case relative to the cellulose used, the reaction time and if appropriate the reaction temperature are set as a function of the desired degree of degradation.

If the cellulose which is made up of an average of x anhydroglucose units is to be converted into a cellulose whose number of anhydroglucose units is less than x, the amounts of water used and acid used are usually matched to the degree of degradation (n_{anhydroglucose units}/n_{acid}>1). The larger the ratio n_{anhydroglucose units}/n_{acid}, the smaller the average degradation of cellulose under otherwise identical reaction conditions and identical reaction time. The larger the ratio n_{anhydroglucose units}/n_{water}, the smaller the average degradation of cellulose under otherwise identical reaction conditions and identical reaction time.

It is also possible to stop the hydrolysis reaction when the desired degree of degradation has been reached by scavenging the acid by means of a base. Suitable bases include both inorganic bases such as alkali metal hydroxides, carbonates, hydrogencarbonates and organic bases such as amines and are used in a stoichiometric ratio to the acid or in excess. In a further embodiment, a hydroxide whose cation corresponds to that of the ionic liquid used can be used as base.

It is also possible to stop the degradation reaction when the desired degree of degradation has been reached by adding appropriate amounts of acylating agent which react with the water still present.

The solution obtained in this way is then used in step B).

As an alternative to step A1), it is also possible to carry out step A2).

In step A2) according to the invention, the cellulose is treated at elevated temperature, if appropriate with addition of water.

If ionic liquids which have no acid functions are used, the degradation is usually carried out at temperatures of from 50 to 200° C., preferably from 80 to 180° C., in particular from 50 to 150° C.

Possible ionic liquids here are ones whose anions are selected from the group of halides, the group of halogen-comprising compounds, the group of carboxylic acids, the group consisting of SO₄²—, SO₃²—, R^{a}OSO₃— and R^{a}SO₃— and the group consisting of PO₄³— and R^{a}R^{b}PO₄—. Preferred anions here are chloride, bromide, iodide, SCN—, OCN—, CN—, acetate, C₁-C₄-alkylsulfates, R^{a}—COO—, R^{a}SO₃—, R^{a}R^{b}PO₄—, methanesulfonate, tosylate or C₁-C₄-dialkylphosphates; particularly preferred anions are Cl—, CH₃COO—, C₂H₅COO—, C₆H₅COO—, CH₃SO₃—, (CH₃O)₂PO₂— or (C₂H₅O)₂PO₂—.

If ionic liquids which have acid functions are used, then it is also possible to lower the reaction temperature. Possible ionic liquids here are, in particular, ones whose anions are selected from the group consisting of HSO₄—, HPO₄²—, H₂PO₄— and HR^{a}PO₄—; in particular HSO₄—.

Reactions in these ionic liquids are preferably carried out at a temperature of from 0 to 150° C., preferably from 20 to 150° C., in particular from 50 to 150° C.

In one embodiment, the preparation of the reaction solution and the degradation are carried out at the same temperature.

In a further embodiment, the preparation of the reaction solution and the degradation are carried out at different temperatures.

It is sometimes also possible for degradation of the cellulose to take place during the preparation of the reaction solution. In a specific embodiment, the dissolution process and the degradation process take place essentially in parallel.

In general, the reaction is carried out in air. However, it is also possible to carry it out under inert gas, i.e., for example, under N₂, a noble gas or mixtures thereof.

The reaction time and the reaction temperature are set as a function of the desired degree of degradation.

In one embodiment, water is added, preferably in substoichiometric amounts, or an excess of water is used and the reaction is stopped.

If the degradation is carried out in the presence of water, it is possible to premix the ionic liquid and the water and to dissolve the cellulose in this mixture. However, it is also possible to add water to the solution of ionic liquid and cellulose.

If the cellulose which is made up of an average of x anhydroglucose units is to be converted into a cellulose whose number of anhydroglucose units is less than x, the amounts of water used are usually matched to the degree of degradation (n_{anhydroglucose units}/n_{water}>1). The larger the ratio n_{anhydroglucose units}/n_{water}, the lower the average degree of degradation of cellulose under otherwise identical reaction conditions and identical reaction time and the higher the DP of the degraded cellulose (which naturally will be lower than the DP of the cellulose used).

In another embodiment, water is not added. This is generally the case when the ionic liquid used contains small amounts of water and/or when water adheres to the cellulose used. The water content of customary cellulose can be up to 10% by weight, based on the total weight of the cellulose used. The above recitations apply mutatis mutandis.

It is also possible to add one or more further solvents to the reaction mixture or to the water if the latter has been added. Possible solvents here are ones which do not adversely affect the solubility of the cellulose, e.g. aprotic dipolar solvents, for example dimethyl sulfoxide, dimethylformamide, dimethylacetamide or sulfolane.

In a particular embodiment, the reaction mixture comprises less than 5% by weight, preferably less than 2% by weight, in particular less than 0.1% by weight, of further solvents, based on the total weight of the reaction mixture.

Furthermore, it is possible to stop the degradation reaction when the desired degree of degradation has been reached by adding appropriate amounts of acylating agent which react with water still present.

The solution obtained in this way is then used in step B).

The acylating agent is then added to the solution obtained from step A).

The carboxylic acid derivative of the formula IV or the ketene of the formula V can be added as such or as a solution in an ionic liquid or in a suitable solvent. Suitable solvents are, for example, ethers such as diethyl ether, methyl tert-butyl ether, tetrahydrofuran or dioxane, or ketones such as dimethyl ketone or halogenated hydrocarbons such as dichloromethane, trichloromethane or dichloroethane. The amount of solvent used to dissolve the carboxylic acid derivative of the formula IV or the ketene of the formula V should be such that no precipitation of the cellulose occurs when the addition is carried out. Ionic liquids used are preferably those in which cellulose itself, as described above, is dissolved.

If the carboxylic acid derivative of the formula IV or the ketene of the formula V is gaseous, this can be passed as gas into the solution of cellulose in the ionic liquid.

In a particular embodiment, the carboxylic acid derivative of the formula IV or the ketene of the formula V is added as such.

In a further particular embodiment, the carboxylic acid derivative of the formula IV or the ketene of the formula V is added as a solution in an ionic liquid, with particular preference being given to using the ionic liquid which is also used for dissolving the cellulose.

It is also possible for one or more further solvents to be added to the reaction mixture or be introduced together with the solution obtained from step A) or be added to the carboxylic acid derivative of the formula IV or the ketene of the formula V. Possible solvents here are solvents which do not adversely affect the solubility of the cellulose, for example aprotic dipolar solvents such as dimethyl sulfoxide, dimethylformamide, dimethylacetamide or sulfolane. Furthermore, nitrogen-comprising bases such as pyridine, etc., can be additionally added.

In a particular embodiment, the reaction mixture comprises, apart from the ionic liquid and any solvent in which the carboxylic acid derivative of the formula IV or the ketene of the formula V has been dissolved, less than 5% by weight, preferably less than 2% by weight, in particular less than 0.1% by weight, based on the total weight of the reaction mixture, of further solvents and/or additional nitrogen-comprising bases.

However, when carboxylic acid derivatives of the formula IV in which X=halogen or OCOR^{x′} are used as acylating agents, it can also be advantageous to carry out the acylation in the presence of a tertiary amine, e.g. triethylamine, an aromatic nitrogen base, e.g. pyridine, or mixtures thereof. The tertiary amine, the aromatic nitrogen base or the mixtures thereof are usually used in the stoichiometric ratio. It can sometimes also be advantageous to use an excess or a substoichiometric amount.

When ketenes of the formula V are used as acylating agent, it is also possible to carry out the acylation according to the invention in the presence of a catalyst. Suitable catalysts here are the alkali metal or alkaline earth metal salts of C₁-C₄-alkanecarboxylic acids or of benzoic acid. Examples are sodium acetate, potassium acetate, sodium propionate, potassium propionate, sodium benzoate or potassium benzoate, preferably sodium acetate. However, it is also possible to use the acids themselves, i.e. the C₁-C₄-alkanecarboxylic acids or benzoic acid. The catalyst is usually used in amounts of up to 10 mol %, preferably up to 8 mol %, based on the ketene of the formula V.

The reaction is, depending on the ionic liquid used and the carboxylic acid derivative of the formula IV used or the ketene of the formula V used, usually carried out at a temperature from the melting point of the ionic liquid to 200° C., preferably from 20 to 180° C., in particular from 50 to 150° C.

In the case of carboxylic acid derivatives of the formula IV or ketenes of the formula V which are liquid or solid at the reaction temperature, the reaction is usually carried out at ambient pressure. However, it can sometimes also be advantageous to carry it out under superatmospheric pressure, particularly when a volatile carboxylic acid derivative of the formula IV or ketene of the formula V is used. In general, the reaction is carried out in air. However, it is also possible to carry it out under inert gas, i.e., for example, under N₂, a noble gas or mixtures thereof.

In the case of carboxylic acid derivatives of the formula IV or ketenes of the formula V which are gaseous at the reaction temperature, it can be advantageous to carry out the reaction under the autogenous pressure of the reaction mixture at the desired reaction temperature or at a pressure which is higher than the autogenous pressure of the reaction system.

However, it can also be advantageous for the reaction with a carboxylic acid derivative of the formula IV or a ketene of the formula V which is gaseous at the reaction temperature to be carried out under ambient pressure and the gaseous carboxylic acid derivative of the formula IV or the ketene of the formula V to be used in excess.

The amount of acylating agent used, in each case relative to the amount of cellulose used, the reaction time and, if appropriate, the reaction temperature are set as a function of the desired degree of substitution of the cellulose.

For example, if the cellulose which is made up of an average of u anhydroglucose units is to be completely acylated, then 3u equivalents of acylating agent are required. Preference is here given to using the stoichiometric amount of acylating agent (n_{acylating agent}/n_{anhydroglucose units}=3) or an excess, preferably an excess of up to 1000 mol % based on u. If the cellulose which is made up of an average of u anhydroglucose units is to be partially acylated, then the amount of acylating agent used is usually adapted accordingly (n_{acylating agent}/n_{anhydroglucose units}<3). The smaller the ratio n_{acylating agent}/n_{anhydroglucose units}, the smaller the average degree of substitution of the acylated cellulose under otherwise identical conditions and identical reaction time.

Furthermore, it is possible to stop the acylation reaction when the desired degree of acylation has been reached by separating off the acylated cellulose from the reaction mixture. This can be effected, for example, by addition of an excess of water or another suitable solvent in which the acylated cellulose is not soluble but the ionic liquid is readily soluble, e.g. a lower alcohol such as methanol, ethanol, propanol or butanol, or a ketone, for example diethyl ketone, etc., or mixtures thereof. The choice of suitable solvent is also determined by the respective degree of substitution and the substituents on the cellulose. Preference is given to using an excess of water or methanol.

The reaction mixture is usually worked up by precipitating the acylated cellulose as described above and filtering off the acylated cellulose. However, it is also possible to carry out the separation by centrifugation. The ionic liquid can be recovered from the filtrate or the centrifugate by conventional methods, by distilling off the volatile components, e.g. the precipitant or excess acylating agent (or reaction products and/or hydrolysis products of the acylating agent), etc. The ionic liquid which remains can be reused in the process of the invention.

However, it is also possible to introduce the reaction mixture into water or into another suitable solvent in which the acylated cellulose is not soluble but the ionic liquid is readily soluble, e.g. a lower alcohol such as methanol, ethanol, propanol or butanol or a ketone, for example diethyl ketone, etc., or mixtures thereof and, depending on the embodiment, obtain, for example, fibers, films of acylated cellulose. The choice of suitable solvent is also determined by the respective degree of substitution and the substituents on the cellulose. The filtrate is worked up as described above.

Furthermore, it is possible to stop the acylation reaction when the desired degree of acylation has been reached by cooling the reaction mixture and working it up. The work-up can be carried out by the methods indicated above.

The acylation reaction can also be stopped by removing acylating agent still present from the reaction mixture by distillation, stripping or extraction with a solvent which forms two phases with the ionic liquid at a given point in time.

In a further embodiment of the present invention, two or more acylating agents are used. In this case, it is possible to use a mixture of two (or more) carboxylic acid derivatives of the formula IV or ketenes of the formula V in a manner analogous to the above procedure. However, it is also possible firstly to carry out the reaction to a DS=a (<3) using the first acylating agent and then carry out the reaction to a DS=b, where a<b≦3, using a second acylating agent.

In this embodiment, acylated celluloses which bear two (or more) different acyl radicals (as a function of the acylating agent used) are obtained.

If the ionic liquid is circulated, the ionic liquid is, in this embodiment, purified, for example freed of the precipitant, any further solvents which have been added, hydrolysis and degradation products of the acylating agent, etc., and reused in step A). In a further embodiment, the ionic liquid which comprises up to 15% by weight, preferably up to 10% by weight, in particular up to 5% by weight, of precipitant(s), etc., as described above, can be used in step A). However, it may in this case sometimes be necessary, for example when the precipitant bears free hydroxy groups, to free the solution obtained in step A) of precipitant still present, etc., for example by distilling off the precipitant still present, etc., before it is used in step B), or an appropriate excess of acylating agent is used.

The process can be carried out batchwise, semicontinuously or continuously.

The present invention also provides a process for acylating cellulose by means of carboxylic acid derivatives of the formula IV as defined above in an ionic liquid of the formula I ([A]ₙ⁺[Y]ₙ₋), or of the formula IIa, b or c ([A¹]⁺[A²]⁺[Y]ₙ₋, where n=2; [A¹]⁺[A²]⁺[A³]⁺[Y]ₙ₋), where n=3; or [A¹]⁺[A²]⁺[A³]⁺[A⁴]⁺[Y]ₙ₋, where n=4), where [A]ₙ⁺, [A¹]⁺,[[A²]⁺, [[A³]⁺, [A³]⁺, [A⁴]+are as defined above and [Y]ⁿ⁻ can be selected from among
the group of halogen-comprising compounds and pseudohalides of the formulae:
   BF₄—, PF₆—, CF₃SO₃—, (CF₃SO₃)₂N—, CF₃CO₃CO₃—, CCl₃CO₂—, CN—, SCN—, OCN—
the group of sulfates, sulfites and sulfonates of the general formulae:
   SO₄²—, HSO₄—, SO₃²—, HSO₃—, R^{a}OSO₃—, R^{a}SO₃—
the group of phosphates of the general formulae:
   PO₄³—, HPO₄²—, H₂PO₄—, R^{a}PO₄²—, HR^{a}PO₄—, R^{a}R^{b}PO₄—
the group of phosphonates and phosphinates of the general formulae:
   R^{a}HPO₃—, R^{a}R^{b}PO₂—, R^{a}R^{b}PO₃—
the group of phosphites of the general formulae:
   PO₃³—, HPO₃²—, H₂PO₃—, R^{a}PO₃²—, R^{a}HPO₃—, R^{a}R^{b}PO₃—
the group of phosphonites and phosphinites of the general formulae:
   R^{a}R^{b}PO₂—, R^{a}HPO₂—, R^{a}R^{b}PO, R^{a}HPO—
the group of carboxylic acids of the general formula:
   R^{a}COO—
the group of borates of the general formulae:
   BO₃³—, HBO₃²—, H₂BO₃—, R^{a}R^{b}BO₃—, R^{a}HBO₃—, R^{a}BO₃²—, B(OR^{a})(OR^{b})(OR^{c})(OR^{d})—, B(HSO₄)—, B(R^{a}SO₄)—
the group of boronates of the general formulae:
   R^{a}BO₂²—, R^{a}R^{b}BO—
the group of silicates and silicic esters of the general formulae:
   SiO₄⁴—, HSiO₄³—, H₂SiO₄²—, H₃SiO₄—, R^{a}SiO₄³—, R^{a}R^{b}SiO₄²—, R^{a}R^{b}R^{c}SiO₄—, HR^{a}SiO₄²—, H₂R^{a}SiO₄—, HR^{a}R^{b}SiO₄—
the group of alkylsilane and arylsilane salts of the general formulae:
   R^{a}SiO₃³—, R^{a}R^{b}SiO₂²—, R^{a}R^{b}R^{c}SiO—, R^{a}R^{b}R^{c}SiO₃—, R^{a}R^{b}R^{c}SiO₂—, R^{a}R^{b}SiO₃²—
the group of carboximides, bis(sulfonyl)imides and sulfonylimides of the general formulae:

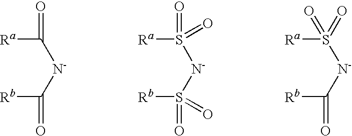

the group of methides of the general formula:

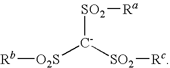

The variables are as defined above. Likewise, the embodiments and modes of operation described above apply analogously here.

The following examples illustrate the invention.

### Preliminary Remark:

Avicel PH 101 or linters were dried overnight at 80° C. or 105° C., respectively, and in each case 0.05 mbar.

The ionic liquids were dried overnight at 120° C. and 0.05 mbar while stirring.

### ABBREVIATIONS

BMIM CI 1-butyl-3-methylimidazolium chloride
BMIM Ac 1-butyl-3-methylimidazolium chloride DS average degree of substitution

### EXAMPLE 1

0.5 g of linters (DP 3250) in 9.5 g of BMIM Cl was introduced into a 25 ml flask provided with magnetic stirrer and reflux condenser at 120° C. and the mixture was stirred under nitrogen for 2 hours until a clear solution had been formed. After addition of 5.90 mg of p-toluenesulfonic acid onohydrate, the mixture was stirred at 100° C. for 6 hours. 3.0 g of acetic anhydride were then added to the mixture and the mixture was stirred at 100° C. for a further 16 hours. After cooling to room temperature, the mixture was introduced into 200 ml of methanol, the precipitated reaction product was filtered off with suction, washed three times with 20 ml of methanol and dried to constant weight at 60° C. and 0.05 mbar for 16 hours. This gave 0.85 g (90% of theory) of a white product having an average degree of st of 2.9 (determined by ¹H-NMR spectroscopy) and an average degree of polymerization of 180.

### EXAMPLE 2

1.072 g of Avicel PH 101 in 11 ml of BMIM Ac was introduced under argon into a 100 ml flask provided with magnetic stirrer and reflux condenser at 100° C. and the mixture was stirred for 2 hours until a clear solution had been formed. After addition of 4.0 g of acetic anhydride, the mixture was stirred at 100° C. for 16 hours. After cooling to room temperature, the mixture was introduced into 200 ml of methanol, the precipitated reaction product was filtered off with suction, washed three times with 20 ml of methanol and dried to constant weight at 60° C. and 0.05 mbar for 16 hours. This gave 1.708 g (91% of theory) of a beige solid having an average degree of substitution of 2.9 (determined by ¹H-NMR spectroscopy).

1: A process for acylating polysaccharides or oligosaccharides, which comprises dissolving a polysaccharide or oligosaccharide in at least one ionic liquid and,
in step A) treating the solution with at least one acid, if appropriate with addition of water, (step A1) or,
if appropriate with addition of water, at elevated temperature (step A2) and,
in step B) reacting the polysaccharide or oligosaccharide obtained in this way, whose DP is lower than that of the polysaccharide or oligosaccharide used, with an acylating agent.

2: The process according to claim 1, wherein a polysaccharide is used as polysaccharide or oligosaccharide.

3: The process according to claim 2, wherein cellulose is used as polysaccharide.

4: The process according to claim 1, wherein the ionic liquid or mixture of ionic liquids is selected from among the compounds of the formula I,
[A]ₙ⁺[Y]ⁿ⁻ (I),
where
n is 1, 2, 3 or 4;
[A]⁺ is a quaternary ammonium cation, an oxonium cation, a sulfonium cation or a phosphonium cation; and
[Y]ⁿ⁻ is a monovalent, divalent, trivalent or tetravalent anion;
or
the compounds of the formulae II
[A¹]⁺[A²]⁺[Y]ⁿ⁻ (IIa),
where n=2;
A¹][A²]⁺[A³]⁺[Y]ⁿ⁻ (IIb),
where n=3; or
A¹]⁺[A²]⁺[A³]⁺[A⁴]⁺[Y]ⁿ⁻ (IIc),
where n=4,
where [A¹]⁺, [A²]⁺, [A³]⁺ and [A⁴]⁺ are selected independently from among the groups mentioned for [A]⁺ and
[Y]ⁿ⁻ is as defined above.

5: The process according to claim 4, wherein [A]⁺ is a cation selected from the group consisting of the compounds of the formulae (IIIa) to (IIIy) 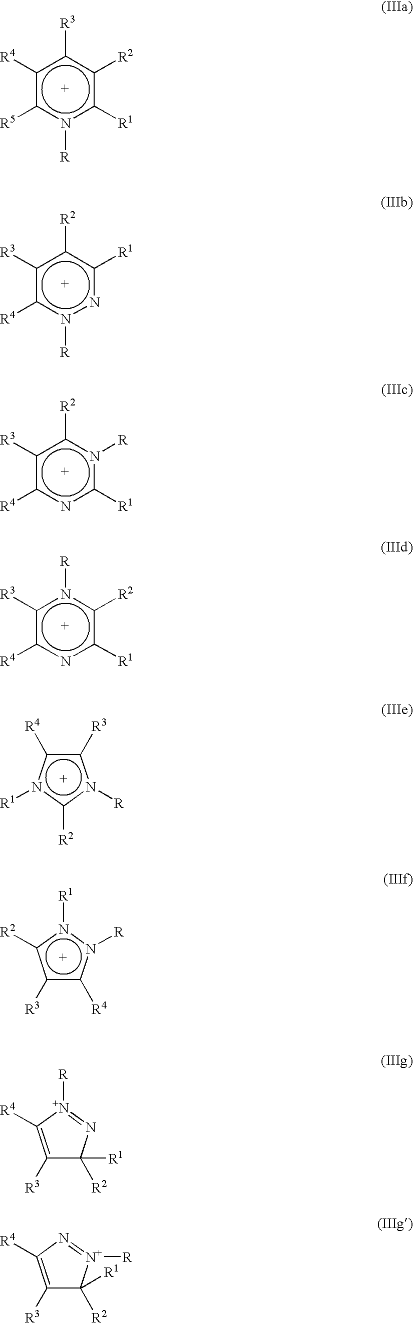 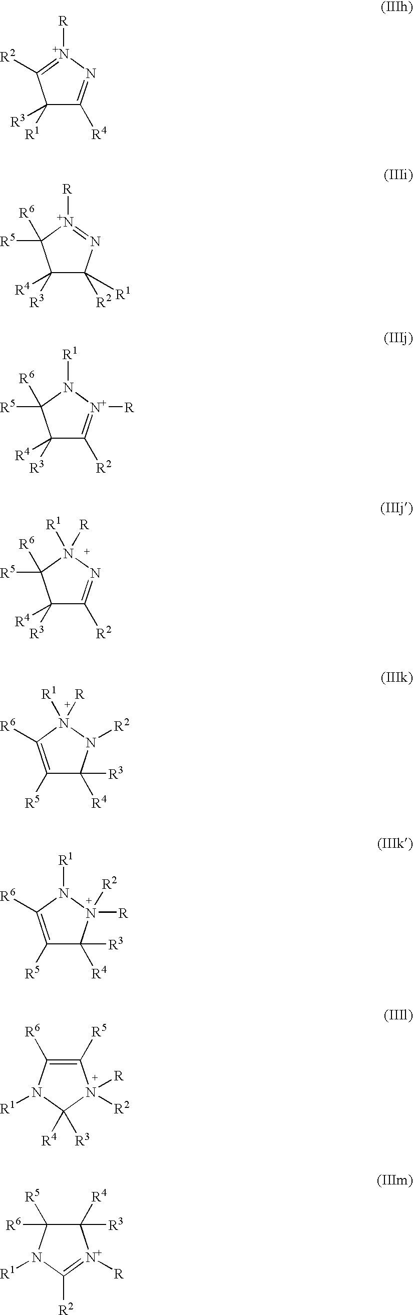 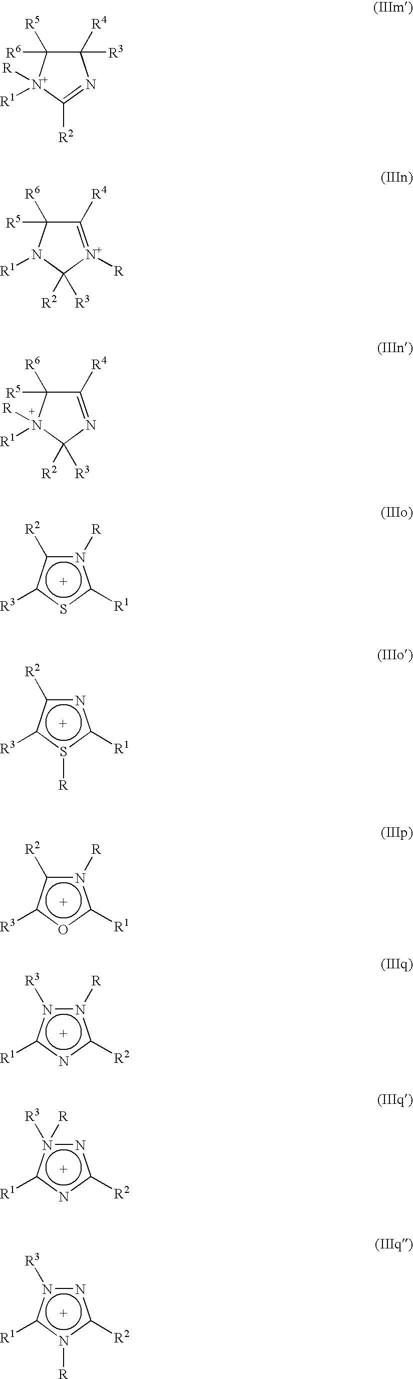 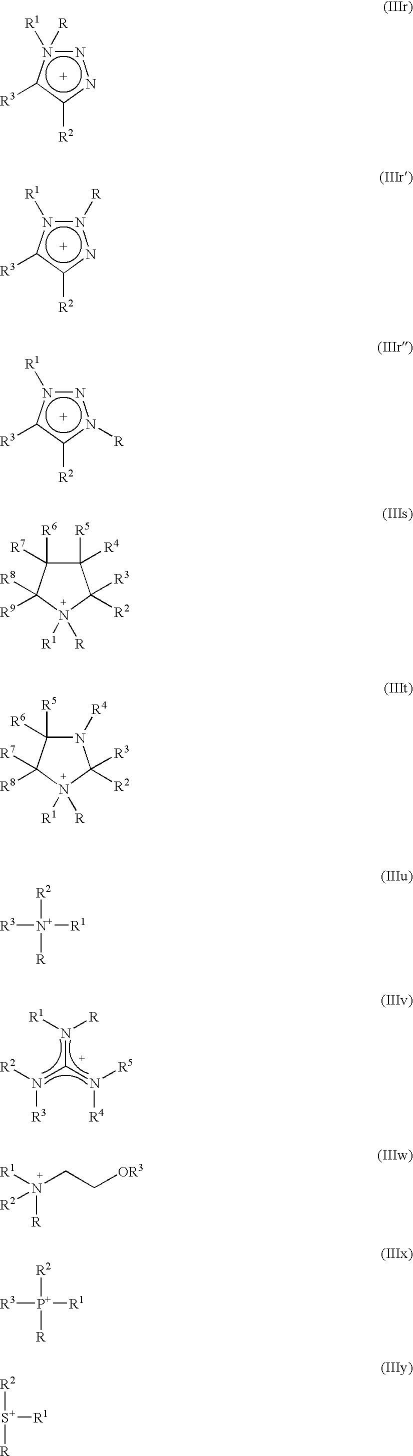
and oligomers comprising these structures, where
the radical R is hydrogen or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups; and
the radicals R¹ to R⁹ are each, independently of one another, hydrogen, a sulfo group or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups, where the radicals R¹ to R⁹ which are bound to a carbon atom (and not to a heteroatom) in the formulae (II) mentioned above are additionally able to be halogen or a functional group; or
two adjacent radicals from the group consisting of R¹ to R⁹ may together also form a divalent, carbon-comprising organic, saturated or unsaturated, acyclic or cyclic, aliphatic, aromatic or araliphatic radical which has from 1 to 30 carbon atoms and may be unsubstituted or be interrupted or substituted by from 1 to 5 heteroatoms or functional groups.

6: The process according to claim 4, wherein [Y]ⁿ⁻ is an anion selected from
the group of halides:
F⁻, Cl⁻, Br⁻, I⁻
the group of halogen-comprising compounds of the formulae:
F⁻, Cl⁻, Br⁻, I⁻, BF₄⁻, PF₆⁻, CF₃SO₃⁻, (CF₃SO₃)₂N⁻, CF₃CO₂⁻, CCl₃CO₂⁻, CN⁻, SCN⁻, OCN⁻
the group of sulfates, sulfites and sulfonates of the general formulae:
SO₄²⁻, HSO₄⁻, SO₃²⁻, HSO₃⁻, R^{a}OSO₃⁻, R^{a}SO₃⁻
the group of phosphates of the general formulae:
PO₄³⁻, HPO₄²⁻, H₂PO₄⁻, R^{a}PO₄²⁻, HR^{a}PO₄⁻, R^{a}R^{b}PO₄⁻
the group of phosphonates and phosphinates of the general formulae:
R^{a}HPO₃⁻, R^{a}R^{b}PO₂⁻, R^{a}R^{b}PO₃⁻
the group of phosphites of the general formulae:
PO₃³⁻, HPO₃²⁻, H₂PO₃₋, R^{a}PO₃²⁻, R^{a}HPO₃₋, R^{a}R^{b}PO₃⁻
the group of phosphonites and phosphinites of the general formulae:
R^{a}R^{b}PO₂⁻, R^{a}HPO₂⁻, R^{a}R^{b}PO⁻, R^{a}HPO⁻
the group of carboxylic acids of the general formula:
R^{a}COO⁻
the group of borates of the general formulae:
BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)⁻, B(R^{a}SO₄)⁻
the group of boronates of the general formulae:
R^{a}BO₂²⁻, R^{a}R^{b}BO⁻
the group of silicates and silicic esters of the general formulae:
SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻
the group of alkylsilane and arylsilane salts of the general formulae:
R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}S₂⁻, R^{a}R^{b}SiO₃²⁻
the group of carboximides, bis(sulfonyl)imides and sulfonylimides of the general formulae: 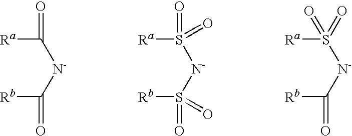
the group of methides of the general formula: 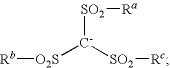
where the radicals R^{a}, R^{b}, R^{c} and R^{d} are each, independently of one another hydrogen, C₁-C₃₀-alkyl, C₂-C₁₈-alkyl which may optionally be interrupted by one or more nonadjacent oxygen and/or sulfur atoms and/or one or more substituted or unsubstituted imino groups, C₆-C₁₄-aryl, C₅-C₁₂-cycloalkyl or a five- or six-membered, oxygen-, nitrogen- and/or sulfur-comprising heterocycle, where two of them may also together form an unsaturated, saturated or aromatic ring which may optionally be interrupted by one or more oxygen and/or sulfur atoms and/or one or more unsubstituted or substituted imino groups, where the radicals mentioned may each be additionally substituted by functional groups, aryl, alkyl, aryloxy, alkyloxy, halogen, heteroatoms and/or heterocycles.

7: The process according to claim 4, wherein [A]⁺ is a cation selected from the group consisting of compounds IIIa, IIIe, IIIf, IIIg, IIIg′, IIIh, IIIi, IIIj, IIIj′, IIIk, IIIk′, IIIl, IIIm, IIIm′, IIIn and IIIn′.

8: The process according to claim 4, wherein [A]⁺ is a cation selected from the group consisting of the compounds IIIa, IIIe and IIIf.

9: The process according to claim 4, wherein [Y]ⁿ⁻ is an anion selected from the group of halides, the group of halogen-comprising compounds, the group of carboxylic acids, the group consisting of SO₄²⁻, SO₃²⁻, R^{a}OSO₃⁻ and R^{a}SO₃⁻ and the group consisting of PO₄³⁻ and R^{a}R^{b}PO₄₋.

10: The process according to claim 1, wherein step A1) is carried out as step A).

11: The process according to claim 10, wherein an inorganic acid, an organic acid or a mixture thereof is used as acid.

12: The process according to claim 1, wherein step A2) is carried out as step A).

13: The process according to claim 1, wherein, in step B), a carboxylic acid derivative of the formula IV 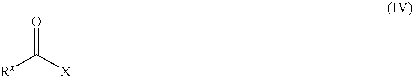
where the radicals have the following meanings:
R^{x}, R^{x′} are each H, C₁-C₃₀-alkyl, C₂-C₃₀-alkenyl, C₂-C₃₀-alkynyl, C₃-C₁₂-cycloalkyl, C₅-C₁₂-cycloalkenyl, aryl or heterocyclyl, where these seven last-named radicals may optionally be substituted;
X is halogen, imidazol-1-yl or O—COR^{x′};
or
a ketene of the formula Va or a diketene of the formula Vb1 or a mixed diketene of the formula Vb2 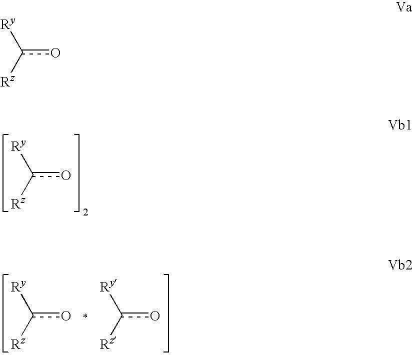
where the radicals have the following meanings:
R^{y}, R^{y′}, R^{z}, R^{z′} are each hydrogen, C₁-C₃₀-alkyl, C₂-C₃₀-alkenyl, C₂-C₃₀-alkynyl, C₃-C₁₂-cycloalkyl, C₅-C₁₂-cycloalkenyl, aryl or heterocyclyl, where the seven last-named radicals may optionally be substituted;
or
R^{y} and R^{z} or R^{y′} and R^{z′} together form an optionally substituted —Yₒ—(CH₂)ₚ—, —(CH₂)_{q}—Y—(CH₂)ᵣ— or a —CH═CH—CH═CH— chain, where
Y is O, S, S(═O), S(═O)₂, NH or NC₁-C₆-alkyl;
o is 0 or 1;
p is 2, 3, 4, 5, 6, 7 or 8;
q, r are each 1, 2, 3, 4, 5 or 6;
is used as acylating agent.

14: The process according to claim 13, wherein a carboxylic acid derivative of the formula IV is used as acylating agent.

15: The process according to claim 14, wherein a carboxylic acid derivative of the formula IV in which X=halogen is used as acylating agent.

16: The process according to claim 14, wherein a carboxylic acid derivative of the formula IV in which X═OCOR^{x′} is used as acylating agent.

17: The process according to claim 13, wherein a ketene of the formula V is used as acylating agent.

18: The process according to claim 1, wherein the initial concentration of polysaccharide or oligosaccharide in the ionic liquid is in the range from 0.1 to 50% by weight, based on the total weight of the solution.

19: The process according to claim 1, wherein steps A) and B) are carried out at a temperature from the melting point of the ionic liquid to 200° C.

20: The process according to claim 1, wherein the acylated polysaccharide or oligosaccharide obtained in the acylation in step B) is quenched by addition of a solvent in which the acylated polysaccharide is not soluble.

21: A process for acylating polysaccharides or oligosaccharides, which comprises reacting the polysaccharide or oligosaccharide in at least one ionic liquid of the formula I, IIa, IIb or IIc, where [A]⁺, [A¹]⁺, [A²]⁺, [A³]⁺ and [A⁴]⁺ are as defined in claim 4 and [Y]ⁿ⁻ is an anion selected from
the group of halides:
F⁻, Cl⁻, Br⁻, I⁻
the group of halogen-comprising compounds of the formulae:
F⁻, Cl⁻, Br⁻, I⁻, BF₄⁻, PF₆⁻, CF₃SO₃⁻, (CF₃SO₃)₂N⁻, CF₃CO₂⁻, CCl₃CO₂⁻, CN⁻, SCN⁻, OCN⁻
the group of sulfates, sulfites and sulfonates of the general formulae:
SO₄²⁻, HSO₄⁻, SO₃²⁻, HSO₃⁻, R^{a}OSO₃⁻, R^{a}SO₃⁻
the group of phosphates of the general formulae:
PO₄³⁻, HPO₄²⁻, H₂PO₄⁻, R^{a}PO₄²⁻, HR^{a}PO₄⁻, R^{a}R^{b}PO₄⁻
the group of phosphonates and phosphinates of the general formulae:
R^{a}HPO₃⁻, R^{a}R^{b}PO₂⁻, R^{a}R^{b}PO₃⁻
the group of phosphites of the general formulae:
PO₃³⁻, HPO₃²⁻, H₂PO₃₋, R^{a}PO₃²⁻, R^{a}HPO₃₋, R^{a}R^{b}PO₃⁻
the group of phosphonites and phosphinites of the general formulae:
R^{a}R^{b}PO₂⁻, R^{a}HPO₂⁻, R^{a}R^{b}PO⁻, R^{a}HPO⁻
the group of carboxylic acids of the general formula:
R^{a}COO⁻
the group of borates of the general formulae:
BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)⁻, B(R^{a}SO₄)⁻
the group of boronates of the general formulae:
R^{a}BO₂²⁻, R^{a}R^{b}BO⁻
the group of silicates and silicic esters of the general formulae:
SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻
the group of alkylsilane and arylsilane salts of the general formulae:
R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}S₂⁻, R^{a}R^{b}SiO₃²⁻
the group of carboximides, bis(sulfonyl)imides and sulfonylimides of the general formulae: 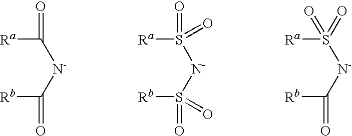
the group of methides of the general formula: 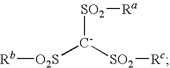
where the radicals R^{a}, R^{a}, R^{b}, R^{c} and R^{d} are each, independently of one another hydrogen, C₁-C₃₀-alkyl, C₂-C₁₈-alkyl which may optionally be interrupted by one or more nonadjacent oxygen and/or sulfur atoms and/or one or more substituted or unsubstituted imino groups, C₆-C₁₄-aryl, C₅-C₁₂-cycloalkyl or a five- or six-membered, oxygen-, nitrogen- and/or sulfur-comprising heterocycle, where two of them may also together form an unsaturated, saturated or aromatic ring which may optionally be interrupted by one or more oxygen and/or sulfur atoms and/or one or more unsubstituted or substituted imino groups, where the radicals mentioned may each be additionally substituted by functional groups, aryl, alkyl, aryloxy, alkyloxy, halogen, heteroatoms and/or heterocycles;
with a carboxylic acid derivative of the formula IV as described in claim 13.

22: The process according to claim 5, wherein [Y]ⁿ⁻ is an anion selected from the group of halides:
F⁻, Cl⁻, Br⁻, I⁻
the group of halogen-comprising compounds of the formulae:
F⁻, Cl⁻, Br⁻, I⁻, BF₄⁻, PF₆⁻, CF₃SO₃⁻, (CF₃SO₃)₂N⁻, CF₃CO₂⁻, CCl₃CO₂⁻, CN⁻, SCN⁻, OCN⁻
the group of sulfates, sulfites and sulfonates of the general formulae
SO₄²⁻, HSO₄⁻, SO₃²⁻, HSO₃⁻, R^{a}OSO₃⁻, R^{a}SO₃⁻
the group of phosphates of the general formulae:
PO₄³⁻, HPO₄²⁻, H₂PO₄⁻, R^{a}PO₄²⁻, HR^{a}PO₄⁻, R^{a}R^{b}PO₄⁻
the group of phosphonates and phosphinates of the general formulae:
R^{a}HPO₃⁻, R^{a}R^{b}PO₂⁻, R^{a}R^{b}PO₃⁻
the group of phosphites of the general formulae:
PO₃³⁻, HPO₃²⁻, H₂PO₃₋, R^{a}PO₃²⁻, R^{a}HPO₃₋, R^{a}R^{b}PO₃⁻
the group of phosphonites and phosphinites of the general formulae:
R^{a}R^{b}PO₂⁻, R^{a}HPO₂⁻, R^{a}R^{b}PO⁻, R^{a}HPO⁻
the group of carboxylic acids of the general formula:
R^{a}COO⁻
the group of borates of the general formulae:
BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)⁻, B(R^{a}SO₄)⁻
the group of boronates of the general formulae:
R^{a}BO₂²⁻, R^{a}R^{b}BO⁻
the group of silicates and silicic esters of the general formulae:
SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻
the group of alkylsilane and arylsilane salts of the general formulae:
R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}S₂⁻, R^{a}R^{b}SiO₃²⁻
the group of carboximides, bis(sulfonyl)imides and sulfonylimides of the general formulae: 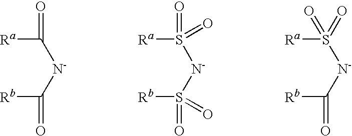
the group of methides of the general formula: 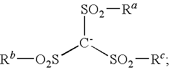
where the radicals R^{a}, R^{b}, R^{c} and R^{d} are each, independently of one another hydrogen, C₁-C₃₀-alkyl, C₂-C₁₈-alkyl which may optionally be interrupted by one or more nonadjacent oxygen and/or sulfur atoms and/or one or more substituted or unsubstituted imino groups, C₆-C₁₄-aryl, C₅-C₁₂-cycloalkyl or a five- or six-membered, oxygen-, nitrogen- and/or sulfur-comprising heterocycle, where two of them may also together form an unsaturated, saturated or aromatic ring which may optionally be interrupted by one or more oxygen and/or sulfur atoms and/or one or more unsubstituted or substituted imino groups, where the radicals mentioned may each be additionally substituted by functional groups, aryl, alkyl, aryloxy, alkyloxy, halogen, heteroatoms and/or heterocycles.

23: The process according to claim 15, wherein X is chloride.

24: The process according to claim 16, wherein X is OCR^{X}.
